(19) United States
(12) Patent Application Publication
(10) Pub. No.: US 2024/0351866 A1
(43) Pub. Date: Oct. 24, 2024

(54) PROCESS FOR THE PRODUCTION OF HYDROGEN THROUGH ELECTRIFICATION OF WATER GAS SHIFT REACTION

(71) Applicant: TOTALENERGIES ONETECH, Courbevoie (FR)

(72) Inventors: Nikolai NESTERENKO, Seneffe (BE); Gleb VERYASOV, Seneffe (BE)

(73) Assignee: TOTALENERGIES ONETECH, Courbevoie (FR)

(21) Appl. No.: 18/685,594

(22) PCT Filed: Sep. 8, 2022
(86) PCT No.: PCT/EP2022/074934

§ 371 Date: Feb. 22, 2024

(30) Foreign Application Priority Data
Sep. 9, 2021 (EP) 21306238.3

(51) Int. Cl. C01B 3/12; C25B 1/02; C25B 1/24; C25B 15/027; C25B 15/08

(52) U.S. Cl. CPC C01B 3/12; C25B 1/02; C25B 1/24; C25B 15/027; C25B 15/081; C01B 2203/0283; C01B 2203/063; C01B 2203/1205; C01B 2203/1614; C01B 2203/1628

(57) ABSTRACT

The present invention relates to a process and a system for the production of hydrogen and carbon dioxide starting from a feed stream comprising carbon monoxide, which is reacted with water and a halogen reactant. The process in particular comprises the steps of: a) reacting in a first reaction zone a feed stream comprising carbon monoxide (CO) with water (H₂O) and bromine (Br₂) under reaction conditions effective to produce a gaseous CO₂-containing effluent stream and an aqueous solution of hydrogen bromide (HBr); and, b) supplying said aqueous solution of hydrogen bromide (HBr) to a second reaction zone and decomposing said hydrogen bromide (HBr) under conditions effective to produce a gaseous H₂-rich stream and a stream comprising bromine (Br₂), wherein said hydrogen bromide is decomposed in step b) by means of electrolysis.

### TECHNICAL FIELD

The present invention in general relates to the field of water-gas shift reactions. In particular, the present invention provides a process for producing a substantially pure stream of hydrogen and a stream containing carbon dioxide starting from a feed stream comprising carbon monoxide. The present process is in particular characterised in that it utilizes a halogen reactant in the production of hydrogen and carbon dioxide starting from a reaction of carbon monoxide with water. The present invention in particular also refers to an electrified process for performing a water-gas shift reaction.

### BACKGROUND

Fossil fuels have been continuously used as the primary source of energy for a long time. These resources are not renewable and pollute the atmosphere through greenhouse gases emission, which is linked to global warming. The depletion in fossil fuel reservoirs as well as the knowledge of their adverse environmental impacts has gained researchers attention to think about alternative and clean sources of energy.

Hydrogen is considered as a promising renewable alternative that minimizes CO₂ emissions and produces only water as a by-product upon combustion. Hydrogen is required for many essential chemical processes. Hydrogen is therefore expected as a future energy medium, and accordingly active research and developments are being performed on wide technical fields including the production, storage and transportation, and utilization of hydrogen. The advantages provided by the use of hydrogen as an energy medium include high energy utilization efficiency, and additionally the fact that the emission after combustion is limited to water.

The principal source of hydrogen produced comes from steam-hydrocarbon processes wherein a hydrocarbon feed material (e.g. fossil fuels such as petroleum, coal, and natural gas) is reacted with steam to produce a product gas comprising carbon monoxide, hydrogen, and carbon dioxide. The steam-hydrocarbon process is complex and requires that the product gas be treated to remove the carbon monoxide and carbon dioxide to obtain substantially pure hydrogen. In addition, if the hydrocarbon feed material contains sulphur, then the feed material or product gas must be treated to remove the sulphur to provide a non-polluting hydrogen gas product.

Other methods of hydrogen production include for instance partial oxidation of methane; biomass gasification, coal gasification; and electrolysis of water. A disadvantage of producing hydrogen by the electrolysis of water is however that the cost is substantially higher than the steam-hydrocarbon process.

Hydrogen may also be produced by a water-gas shift (WGS) reaction.

In the WGS reaction, water reacts with CO to form hydrogen and carbon dioxide (CO+H₂O<->CO₂+H₂), where the CO₂ can be separated from the stream to get pure hydrogen. The WGS is relevant to various industrial sectors, directly or indirectly, such as the fertilizer industry for the production of ammonia, in the production of hydrocarbons, methanol, and other bulk chemicals utilizing syngas. It is also often used in conjunction with steam reforming of methane and other hydrocarbons. Besides the production of hydrogen, the WGS reaction finds many other applications, for instance in adjustment of H₂/CO ratio in syngas, and in removal of toxic CO from possible gas streams. The reaction typically requires a catalyst and produces a mixed stream comprising CO₂, H₂ and H₂O and therefore requires further separation. Catalysts for use in water gas shift reaction are well known in the art.

There remains a continuous need in the art to further improve methods for producing hydrogen which are more cost effective, which use renewable sources of energy, and/or which are more efficient when the production of hydrogen and the recovery of carbon dioxide are simultaneously performed, such as in a WGS reaction.

It is therefore an object of the present invention to provide a process for producing of hydrogen which allows to fulfil at least some of the above indicated needs.

### SUMMARY OF THE INVENTION

In accordance with the present invention an improved process for producing a substantially pure stream of hydrogen is provided.

In a first aspect, the present invention thereto provides a process for producing hydrogen and carbon dioxide from carbon monoxide and water.

The present invention relates to a process for producing hydrogen and carbon dioxide from carbon monoxide and water, comprising the steps of:
a) reacting in a first reaction zone a feed stream comprising carbon monoxide (CO) with water (H₂O) and at least one halogen reactant (X₂) under reaction conditions effective to produce a gaseous CO₂-containing effluent stream and an aqueous solution of hydrogen halide (HX); and,
b) supplying said aqueous solution of hydrogen halide (HX) to a second reaction zone and decomposing said hydrogen halide (HX) under conditions effective to produce a gaseous H₂-rich stream and a stream comprising halogen reactant (X₂).

In a preferred embodiment of the process said halogen reactant is bromine and said hydrogen halide is hydrogen bromide.

In a preferred embodiment of the process, the decomposition of the hydrogen halide in step b) of the process is accomplished by means of electrolytic decomposition (electrolysis). The present process therefore advantageously provides a process for production of hydrogen through electrification of a water gas shift reaction.

The present invention provides a process for producing hydrogen and carbon dioxide from carbon monoxide and water, comprising the steps of:
a) reacting in a first reaction zone a feed stream comprising carbon monoxide (CO) with water (H₂O) and at least one halogen reactant, wherein said halogen reactant is bromine (Br₂) under reaction conditions effective to produce a gaseous CO₂-containing effluent stream and an aqueous solution of hydrogen bromide (HBr); and,
b) supplying said aqueous solution of hydrogen bromide (HBr) to a second reaction zone and decomposing by means of electrolysis said hydrogen bromide (HBr) under conditions effective to produce a gaseous H₂-rich stream and a stream comprising bromine (Br₂).

The present invention provides a process for performing a water-gas shift reaction. The Applicant has surprisingly established that such process may advantageously be carried out in essentially two reaction steps, wherein a halogen reactant, such as bromine (Br₂) is applied in the first reaction step.

A first step of the process (step a) comprises the reaction of a feed stream comprising carbon monoxide (CO) with water (or water vapor) and at least one halogen reactant, and hence involves the oxidation of CO in presence of water and the halogen to form a CO₂-containing effluent stream and an aqueous solution of hydrogen halide.

The first reaction step may be represented by the following equation (using bromine as example for the halogen reactant):

Step a): CO+Br₂+H₂O→CO₂+2 HBr

The present process thus allows the recovery of a CO₂-containing stream after this first step by separating the formed hydrogen halide from the CO₂-containing effluent stream.

A second reaction step (step b) of the process then involves the production of hydrogen and the recovery of the halogen reactant from the hydrogen halide formed in the first reaction step. The formed hydrogen halide is decomposed to release hydrogen and the halogen reactant.

The second reaction step may be represented by the following equation (using bromine as example for the halogen reactant and hydrogen bromide as the hydrogen halide):

Step b) 2 HBr→H₂+Br₂

In accordance with the present invention, both reaction steps are performed in separate reaction zones. The first reaction zone is different and separated from the second reaction zone. The present process thus advantageously allows to perform CO oxidation and hydrogen generation in different reaction zones to (separately) generate a stream containing CO₂, and a stream containing hydrogen.

In certain preferred embodiments, the present process comprises the further step of returning the halogen reactant, such as bromine, obtained in step b), or a part thereof, to step a) of the process.

The present process allows to produce a stream containing CO₂, which can be readily applied in carbon capture and storage processes (CCS) processes; and a stream rich in hydrogen, and preferably essentially consisting of hydrogen, which can be further used in numerous downstream applications. Advantageously, the feed stream reacted in step a) may be an effluent stream from a CO-generating process, such as, but not limited to e.g. a combustion process of carbon-containing feedstock, or a conversion process of a hydrocarbon-containing feedstock, such as natural gas, mineral oils, or coal; or a coal gasification process.

In a second aspect, the present invention provides a system for producing hydrogen and carbon dioxide from carbon monoxide and water.

In one embodiment a system for producing hydrogen and carbon dioxide from carbon monoxide and water is provided, comprising
at least one first reaction zone configured to react a feed stream comprising carbon monoxide (CO) with water (H₂O) and at least one halogen reactant (X₂) into a gaseous CO₂-containing effluent stream and an aqueous solution of hydrogen halide (HX);
at least one second reaction zone, separated from said first reaction zone, and configured to receive an aqueous solution of hydrogen halide and to decompose said hydrogen halide solution into a gaseous H₂-rich stream and a stream comprising halogen reactant;
means for supplying a feed stream comprising carbon monoxide (CO) to said first reaction zone;
means for supplying water to said first reaction zone;
means for supplying a solution of a halogen reactant to said first reaction zone;
means for separately recovering a gaseous CO₂-containing effluent stream and an aqueous solution of hydrogen halide (HX) from said first reaction zone;
means for supplying an aqueous solution of hydrogen halide (HX) recovered from said first reaction zone to said second reaction zone;
means for separately recovering a gaseous H₂-rich stream and a stream comprising halogen reactant from said second reaction zone;
optionally, means for returning the stream of halogen reactant, or a part thereof, recovered from said second reaction zone to said first reaction zone;
optionally, wherein said second reaction zone comprises an electrolysis unit comprising at least one electrolysis cell and a power source for supplying current to said electrolysis cell; and
optionally, means for supplying a complexing agent to said second reaction zone.

In another embodiment, a system for producing hydrogen and carbon dioxide from carbon monoxide and water is provided, comprising
at least one first reaction zone configured to react a feed stream comprising carbon monoxide (CO) with water (H₂O) and a halogen reactant, wherein said halogen reactant is bromine (Br₂) into a gaseous CO₂-containing effluent stream and an aqueous solution of hydrogen bromide (HBr);
at least one second reaction zone, separated from said first reaction zone, and configured to receive an aqueous solution of hydrogen bromide and to decompose said hydrogen bromide solution into a gaseous H₂-rich stream and a stream comprising bromine;
means for supplying a feed stream comprising carbon monoxide (CO) to said first reaction zone;
means for supplying water to said first reaction zone;
means for supplying a solution of a bromine to said first reaction zone;
means for separately recovering a gaseous CO₂-containing effluent stream and an aqueous solution of hydrogen bromide (HBr) from said first reaction zone;
means for supplying an aqueous solution of hydrogen bromide (HBr) recovered from said first reaction zone to said second reaction zone,
means for separately recovering a gaseous H₂-rich stream and a stream comprising bromine from said second reaction zone; and
optionally, means for returning the stream of bromine, or a part thereof, recovered from said second reaction zone to said first reaction zone,
wherein said second reaction zone comprises an electrolysis unit comprising at least one electrolysis cell and a power source for supplying current to said electrolysis cell, and
optionally, means for supplying a complexing agent to said second reaction zone.

The present process and system provide a continuous, substantially non-polluting, economical two step process of producing a stream of hydrogen and a stream comprising CO₂, which can be readily applied in various downstream processes. In preferred embodiments, the present invention advantageously provides a process and system for the production of hydrogen through electrification of a water gas shift reaction. Advantageously, the feedstock containing CO may be obtained as an effluent stream from a (separate) CO-generating processes, allowing the present process to be fully integrated into such processes.

The independent and dependent claims set out particular and preferred features of the invention. Features from the dependent claims may be combined with features of the independent or other dependent claims as appropriate.

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

### DETAILED DESCRIPTION OF THE FIGURES

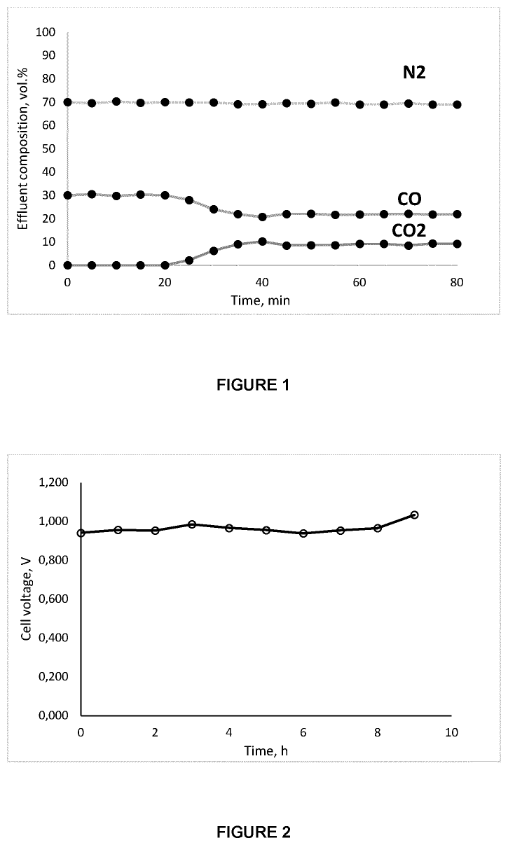

FIG. 1 illustrates the composition in terms of nitrogen, CO and CO₂ of the effluent stream obtained in the reaction described in example 1.

FIG. 2 illustrates the stable operation for more than 9 hours of an electrochemical cell as applied in example 1.

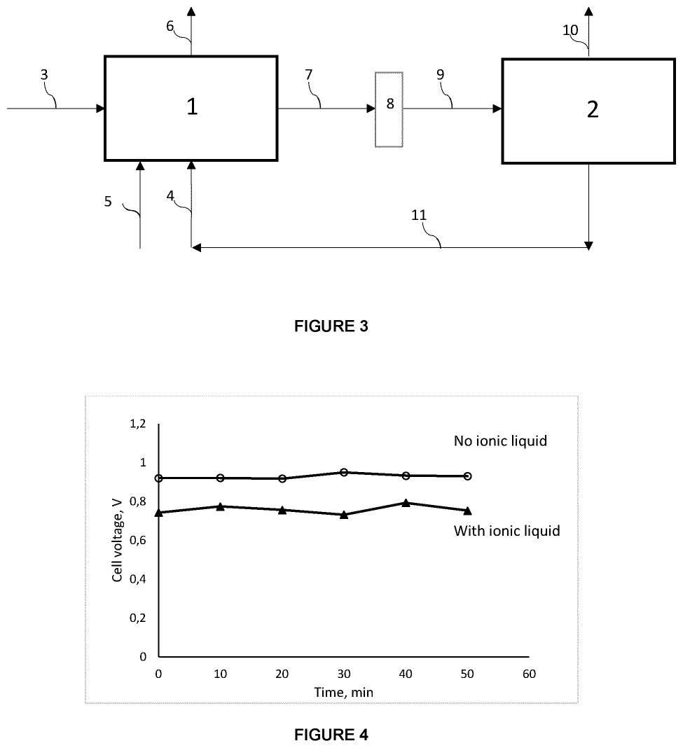

FIG. 3 illustrates an embodiment of an embodiment of a system according to the invention.

FIG. 4 illustrates the energy requirement (in cell voltage) when carrying out process step b) according to the invention in the presence or absence of a ionic liquid as complexing agent, as described in example 3.

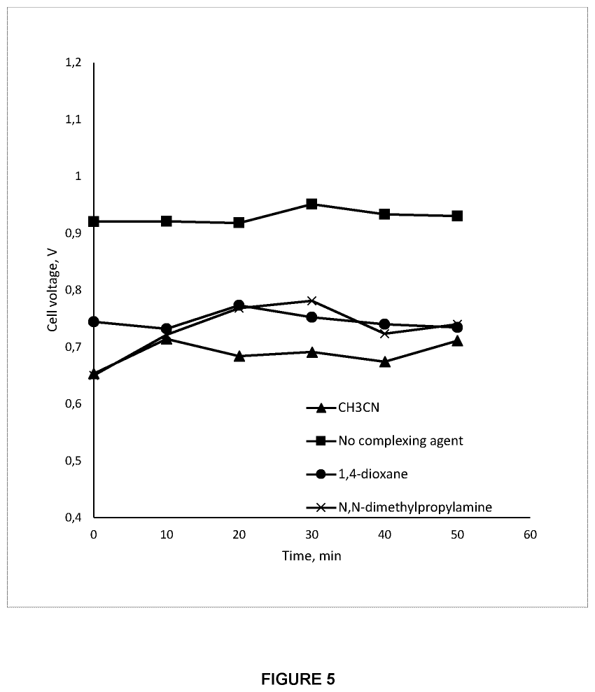

FIG. 5 illustrates the energy requirement (in cell voltage) for carrying out process step b) according to the invention in the presence or absence of a complexing agent, as described in the experiments of example 4.

### DETAILED DESCRIPTION OF THE INVENTION

When describing the invention, the terms used are to be construed in accordance with the following definitions, unless a context dictates otherwise.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art.

The terms “comprising”, “comprises” and “comprised of” as used herein are synonymous with “including”, “includes” or “containing”, “contains”, and are inclusive or open-ended and do not exclude additional, non-recited members, elements, or method steps. It will be appreciated that the terms “comprising”, “comprises” and “comprised of” as used herein comprise the terms “consisting of”, “consists” and “consists of”.

As used in the specification and the appended claims, the singular forms “a”, “an,” and “the” include plural referents unless the context clearly dictates otherwise. By way of example, “a step” means one step or more than one step.

Unless defined otherwise, all technical and scientific terms used herein have the same meaning as is commonly understood by one of skill in the art.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of endpoints also includes the end point values themselves (e.g. from 1.0 to 5.0 includes both 1.0 and 5.0). Any numerical range recited herein is intended to include all sub-ranges subsumed therein.

The term “about” as used herein when referring to a measurable value such as a parameter, an amount, a temporal duration, and the like, is meant to encompass variations of +/−10% or less, preferably +/−5% or less, more preferably +/−1% or less, of and from the specified value, insofar such variations are appropriate to perform in the disclosed invention. It is to be understood that the value to which the modifier “about” refers is itself also specifically, and preferably, disclosed.

When describing the present invention, the terms used are to be construed in accordance with the following definitions, unless a context dictates otherwise.

Whenever the term “substituted” is used in the present invention, it is meant to indicate that one or more hydrogens on the atom indicated in the expression using “substituted” is replaced with a selection from the indicated group, provided that the indicated atom's normal valency is not exceeded, and that the substitution results in a chemically stable compound, i.e. a compound that is sufficiently robust to survive isolation to a useful degree of purity from a reaction mixture.

The term “alkyl” as a group or part of a group, refers to a hydrocarbyl group of formula CₙH₂ₙ₊₁ wherein n is a number greater than or equal to 1. Alkyl groups may be linear or branched and may be substituted as indicated herein. Generally, alkyl groups of this invention comprise from 1 to 20 carbon atoms, preferably from 1 to 18 carbon atoms, preferably from 1 to 12 carbon atoms, preferably from 1 to 10 carbon atoms, preferably from 1 to 6 carbon atoms, more preferably 1, 2, 3, 4, 5, 6 carbon atoms. When a subscript is used herein following a carbon atom, the subscript refers to the number of carbon atoms that the named group may contain. For example, the term “C₁₋₂₀alkyl”, as a group or part of a group, refers to a hydrocarbyl group of formula —CₙH₂ₙ₊₁ wherein n is a number ranging from 1 to 20. Thus, for example, C₁₋₂₀alkyl groups include all linear, or branched alkyl groups having 1 to 20 carbon atoms, and thus includes for example methyl, ethyl, n-propyl, i-propyl, 2-methyl-ethyl, butyl and its isomers (e.g. n-butyl, i-butyl and t-butyl); pentyl and its isomers, hexyl and its isomers, heptyl and its isomers, octyl and its isomers, nonyl and its isomers, decyl and its isomers, undecyl and its isomers, dodecyl and its isomers, tridecyl and its isomers, tetradecyl and its isomers, pentadecyl and its isomers, hexadecyl and its isomers, heptadecyl and its isomers, octadecyl and its isomers, and the like. For example, C₁₋₁₀alkyl includes all linear, or branched alkyl groups having 1 to 10 carbon atoms, and thus includes for example methyl, ethyl, n-propyl, i-propyl, 2-methyl-ethyl, butyl and its isomers (e.g. n-butyl, i-butyl, and t-butyl); pentyl and its isomers, hexyl and its isomers, heptyl and its isomers, octyl and its isomers, nonyl and its isomers, decyl and its isomers and the like. For example, C₁₋₆alkyl includes all linear, or branched alkyl groups having 1 to 6 carbon atoms, and thus includes for example methyl, ethyl, n-propyl, i-propyl, 2-methyl-ethyl, butyl and its isomers (e.g. n-butyl, i-butyl, and t-butyl); pentyl and its isomers, hexyl and its isomers. In some embodiments, non-limiting examples of alkyl groups include for instance methyl, ethyl, propyl, iso-propyl, n-butyl, isobutyl, sec-butyl, t-butyl, pentyl, isopentyl, 2,2-dimethyl-propyl, hexyl, 2,3-dimethyl-2-butyl, heptyl, 2,2-dimethyl-3-pentyl, 2-methyl-2-hexyl, octyl, 4-methyl-3-heptyl, nonyl, decyl, undecyl and dodecyl groups. When the suffix “ene” is used in conjunction with an alkyl group, i.e. “alkylene”, this is intended to mean the alkyl group as defined herein having two single bonds as points of attachment to other groups. Alkylene groups may be linear or branched and may be substituted as indicated herein. Non-limiting examples of alkylene groups include methylene (—CH₂—), ethylene (—CH₂—CH₂—), methylmethylene (—CH(CH₃)—), 1-methyl-ethylene (—CH(CH₃)—CH₂—), n-propylene (—CH₂—CH₂—CH₂—), 2-methylpropylene (—CH₂—CH(CH₃)—CH₂—), 3-methylpropylene (—CH₂—CH₂—CH(CH₃)—), n-butylene (—CH₂—CH₂—CH₂—CH₂—), 2-methylbutylene (—CH₂—CH(CH₃)—CH₂—CH₂—), 4-methylbutylene (—CH₂—CH₂—CH₂—CH(CH₃)—), pentylene and its chain isomers, hexylene and its chain isomers.

As used herein and unless otherwise stated, the term “halo” or “halogen”, as a group or part of a group, is generic for any atom selected from the group consisting of fluorine (F), chlorine (Cl), bromine (Br), iodine (I) and astatine (At).

The term “haloalkyl” as a group or part of a group, refers to an alkyl group having the meaning as defined above wherein at least one hydrogen atom is replaced with a halogen as defined herein. Non-limiting examples of such haloalkyl groups include chloromethyl, 1-bromoethyl, fluoromethyl, difluoromethyl, trifluoromethyl, 1,1,1-trifluoroethyl and the like.

The term “aryl”, as a group or part of a group, refers to a polyunsaturated, aromatic hydrocarbyl group having a single ring (i.e., phenyl) or multiple aromatic rings fused together (e.g., naphthyl), or linked covalently, typically containing 5 to 18 atoms, wherein at least one ring is aromatic. The aromatic ring may optionally include one to two additional rings (either cycloalkyl, heterocyclyl or heteroaryl) fused thereto. Examples of suitable aryl include C₅₋₁₈aryl, or C₅₋₁₂aryl, or C₅₋₁₀aryl, or C₆₋₁₂aryl, or C₆₋₁₀aryl. Non-limiting examples of aryl comprise phenyl, biphenylyl, biphenylenyl, or 1- or 2-naphthanelyl; 1-, 2-, 3-, 4-, 5- or 6-tetralinyl (also known as “1,2,3,4-tetrahydronaphtalene); 1-, 2-, 3-, 4-, 5-, 6-, 7- or 8-azulenyl, 4-, 5-, 6 or 7-indenyl; 4- or 5-indanyl; 5-, 6-, 7- or 8-tetrahydronaphthyl; 1,2,3,4-tetrahydronaphthyl; and 1,4-dihydronaphthyl; 1-, 2-, 3-, 4- or 5-pyrenyl. When the suffix “ene” is used in conjunction with an aryl group, this is intended to mean the aryl group as defined herein having two single bonds as points of attachment to other groups.

The term “alkoxy” or “alkyloxy”, as a group or part of a group, refers to a group having the Formula —OR^{x1} wherein R^{x1} is alkyl as defined herein above. Examples of suitable alkyloxy include C₁₋₂₀alkyloxy, or C₁₋₁₈alkyloxy, or C₁₋₁₂alkyloxy, or C₁₋₆alkyloxy. Non-limiting examples of suitable alkoxy include, but are not limited to methoxy, ethoxy, propoxy, isopropoxy, butoxy, isobutoxy, sec-butoxy, tert-butoxy, pentyloxy, and hexyloxy.

The term “aryloxy”, as a group or part of a group, refers to a group having the formula —OR^{x2} wherein R^{x2} is aryl as defined herein. Examples of suitable aryloxy include C₅₋₃₀aryloxy, or C₆₋₃₀aryloxy, or C₆₋₁₂aryloxy.

The term “cycloalkyl”, as a group or part of a group, refers to a cyclic alkyl group, that is to say, a monovalent, saturated, hydrocarbyl group having 1 or more cyclic structure. Generally, cycloalkyl groups of this invention comprise from 3 to 20 carbon atoms, preferably from 3 to 12 carbon atoms, preferably from 3 to 10 carbon atoms, preferably from 3 to 8 carbon atoms, or from 3 to 6 carbon atoms, or from 5 to 6 carbon atoms. Cycloalkyl includes all saturated hydrocarbon groups containing 1 or more rings, including monocyclic or bicyclic groups. The further rings of multi-ring cycloalkyls may be either fused, bridged and/or joined through one or more spiro atoms. When a subscript is used herein following a carbon atom, the subscript refers to the number of carbon atoms that the named group may contain. For example, the term “C₃₋₂₀cycloalkyl”, a cyclic alkyl group comprising from 3 to 20 carbon atoms. For example, the term “C₃₋₁₀cycloalkyl”, a cyclic alkyl group comprising from 3 to 10 carbon atoms. For example, the term “C₃₋₈cycloalkyl”, a cyclic alkyl group comprising from 3 to 8 carbon atoms. For example, the term “C₃₋₆cycloalkyl”, a cyclic alkyl group comprising from 3 to 6 carbon atoms. Examples of C₃₋₁₂cycloalkyl groups include but are not limited to adamantly, cyclopropyl, cyclobutyl, cyclopentyl, cyclohexyl, cycloheptyl, cyclooctyl, 1,2-diethylcyclohexyl, bicyclo[2.2.1]heptan-2yl, (1S,4R)-norbornan-2-yl, (1R,4R)-norbornan-2-yl, (1S,4S)-norbornan-2-yl, (1R,4S)-norbornan-2-yl.

The term “heterocyclyl”, as a group or part of a group, refers to non-aromatic, fully saturated or partially unsaturated ring system of 3 to 18 atoms including at least one N, O, S, or P (for example, 3 to 7 member monocyclic, 7 to 11 member bicyclic, or comprising a total of 3 to 10 ring atoms) wherein at least one ring is a heterocyclyl and wherein said ring may be fused to an aryl, cycloalkyl, heteroaryl and/or heterocyclyl ring. Each ring of the heterocyclyl may have 1, 2, 3 or 4 heteroatoms selected from N, P, O or S, where the N and S heteroatoms may optionally be oxidized and the N heteroatoms may optionally be quaternized; and wherein at least one carbon atom of heterocyclyl can be oxidized to form at least one C═O. The heterocyclic may be attached at any heteroatom or carbon atom of the ring or ring system, where valence allows. The rings of multi-ring heterocyclyls may be fused, bridged and/or joined through one or more spiro atoms.

In some embodiments, non-limiting examples of heterocyclic rings systems include for instance aziridine, azirine, oxirane, oxirene, phosphirane, phosphirene, azetidine, azete, oxetane, oxete, thietane, thiete, diazetidine, diazete, dioxetane, dioxete, dithietane, dithiete, pyrrolidine, pyrrole, tetrahydrofuran, furan, phospholane, phosphole, tetrahydrothiophene, thiophene, imidazolidine, pyrazolidine, imidazole, pyrazole, oxathiolidine, isoxthiolidine, oxathiole isoxathiole, oxazolidine, isoxazolidine, oxazole, isoxazole, thiazolidine, isothiazolidine, thiazole, isothiazole, dioxolane, dithiolane, triazole, furazan, oxadiazole, thiadiazole, dioxazole, dithiazole, tetrazole, oxatetrazole, thiatetrazole, petazole, piperidine, pyridine, oxane, pyran, phosphinane, phosphinine, thiane, siline, diazinane, diazine, mopholine, oxazine, thiomorpholine, thiazine, dioxane, dioxine, dithiane, dithiin, triazinane, triazine, tripxane, trithiane, tetrazine, pentazine, azepane, azepine, oxepane, oxepine, thiepane, thiepine, diazepane, diazepine, thiazepine, azocane, azocine, oxocane, oxocine, thiocane, thiocine, azonane, azonine, oxonane, oxonine, thionane, and thionine.

Non limiting exemplary heterocyclic groups include piperidinyl, piperazinyl, homopiperazinyl, morpholinyl, tetrahydropyranyl, tetrahydrofuranyl, pyrrolidinyl, aziridinyl, oxiranyl, thiiranyl, azetidinyl, oxetanyl, thietanyl, 2-imidazolinyl, pyrazolidinyl imidazolidinyl, isoxazolinyl, oxazolidinyl, isoxazolidinyl, thiazolidinyl, isothiazolidinyl, succinimidyl, 3H-indolyl, indolinyl, isoindolinyl, chromanyl (also known as 3,4-dihydrobenzo[b]pyranyl), 2H-pyrrolyl, 1-pyrrolinyl, 2-pyrrolinyl, 3-pyrrolinyl, 4H-quinolizinyl, 2-oxopiperazinyl, 2-pyrazolinyl, 3-pyrazolinyl, tetrahydro-2H-pyranyl, 2H-pyranyl, 4H-pyranyl, 3,4-dihydro-2H-pyranyl, 3-dioxolanyl, 1,4-dioxanyl, 2,5-dioximidazolidinyl, 2-oxopiperidinyl, 2-oxopyrrolodinyl, indolinyl, tetrahydrothiophenyl, tetrahydroquinolinyl, tetrahydroisoquinolin-1-yl, tetrahydroisoquinolin-2-yl, tetrahydroisoquinolin-3-yl, tetrahydroisoquinolin-4-yl, thiomorpholin-4-yl, thiomorpholin-4-ylsulfoxide, thiomorpholin-4-ylsulfone, 1,3-dioxolanyl, 1,4-oxathianyl, 1,4-dithianyl, 1,3,5-trioxanyl, 1H-pyrrolizinyl, tetrahydro-1,1-dioxothiophenyl, N-formylpiperazinyl, and morpholin-4-yl.

The term “heteroaryl”, as a group or part of a group, refers to an aromatic ring system of 5 to 30 atoms including at least one N, O, S, or P, containing 1 or more rings, such as 1 or 2 or 3 or 4 rings, which can be fused together or linked covalently, each ring typically containing 5 to 6 atoms; at least one of said ring is aromatic, where the N and S heteroatoms may optionally be oxidized and the N heteroatoms may optionally be quaternized, and wherein at least one carbon atom of said heteroaryl can be oxidized to form at least one C═O. Such rings may be fused to an aryl, cycloalkyl, heteroaryl and/or heterocyclyl ring.

Non-limiting examples of such heteroaryl, include: triazol-2-yl, pyridinyl, 1H-pyrazol-5-yl, pyrrolyl, furanyl, thiophenyl, pyrazolyl, imidazolyl, oxazolyl, isoxazolyl, thiazolyl, isothiazolyl, triazolyl, oxadiazolyl, thiadiazolyl, tetrazolyl, oxatriazolyl, thiatriazolyl, pyrimidyl, pyrazinyl, pyridazinyl, oxazinyl, dioxinyl, thiazinyl, triazinyl, imidazo[2,1-b][1,3]thiazolyl, thieno[3,2-b]furanyl, thieno[3,2-b]thiophenyl, thieno[2,3-d][1,3]thiazolyl, thieno[2,3-d]imidazolyl, tetrazolo[1,5-a]pyridinyl, indolyl, indolizinyl, isoindolyl, benzofuranyl, isobenzofuranyl, benzothiophenyl, isobenzothiophenyl, indazolyl, benzimidazolyl, 1,3-benzoxazolyl, 1,2-benzisoxazolyl, 2,1-benzisoxazolyl, 1,3-benzothiazolyl, 1,2-benzoisothiazolyl, 2,1-benzoisothiazolyl, benzotriazolyl, 1,2,3-benzoxadiazolyl, 2,1,3-benzoxadiazolyl, 1,2,3-benzothiadiazolyl, 2,1,3-benzothiadiazolyl, benzo[d]oxazol-2 (3H)-one, 2,3-dihydro-benzofuranyl, thienopyridinyl, purinyl, imidazo[1,2-a]pyridinyl, 6-oxo-pyridazin-1 (6H)-yl, 2-oxopyridin-1 (2H)-yl, 6-oxo-pyridazin-1 (6H)-yl, 2-oxopyridin-1 (2H)-yl, 1,3-benzodioxolyl, quinolinyl, isoquinolinyl, cinnolinyl, quinazolinyl, quinoxalinyl; preferably said heteroaryl group is selected from the group consisting of pyridyl, 1,3-benzodioxolyl, benzo[d]oxazol-2 (3H)-one, 2,3-dihydro-benzofuranyl, pyrazinyl, pyrazolyl, pyrrolyl, isoxazolyl, thiophenyl, imidazolyl, benzimidazolyl, pyrimidinyl, s-triazinyl, oxazolyl, isothiazolyl, furyl, thienyl, triazolyl thiazolyl, 5H-[1,2,4]triazino[5,6-b]indole, and 3,5,6,8,10,11-hexaazatricyclo[7.3.0.0^{2,6}]dodeca-1(9),2,4,7,11-pentaenyl.

The term “heteroalkyl” as used herein refers to an alkyl wherein one or more carbon atoms are replaced by one or more atoms independently selected from the group consisting of O, P, N and S, with the proviso that said chain may not contain two adjacent O atoms or two adjacent S atoms. Said one or more atoms replacing said carbon atoms may be positioned at the beginning of the hydrocarbon chain, in the hydrocarbon chain or at the end of the hydrocarbon chain. This means that one or more —CH₃ of said alkyl can be replaced by —NH₂ and/or that one or more —CH₂— of said alkyl can be replaced by —NH—, —O— or —S—. In some embodiments the term heteroalkyl encompasses an alkyl which comprises one or more heteroatoms in the hydrocarbon chain, said heteroatoms being selected from the atoms consisting of O, S, P, and N, whereas the heteroatoms may be positioned at the beginning of the hydrocarbon chain, in the hydrocarbon chain or at the end of the hydrocarbon chain. The S atoms in said chains may be optionally oxidized with one or two oxygen atoms, to afford sulfoxides and sulfones, respectively. Furthermore, the heteroalkyl groups in the compounds of the present invention can contain an oxo or thio group at any carbon or heteroatom that will result in a stable compound. Exemplary heteroalkyl groups include, but are not limited to, alcohols, alkyl ethers, primary, secondary, and tertiary alkyl amines, amides, ketones, esters, alkyl sulfides, and alkyl sulfones. The term heteroalkyl thus comprises but is not limited to —R^{x4}—S—; —R^{x4}—O—, —R^{x4}—N(R^{x3})₂—O—R^{x1}, —NR^{x3}—R^{x1}, —R^{x4}—O—R^{x1}, —O—R^{x4}—S—R^{x1}, —S—R^{x4}—, —O—R^{x4}—NR^{x3}R^{x1}, —NR^{x3}—R^{x4}—S—R^{x1}, —R^{x4}—NR^{x3}—R^{x1}, —NR^{x3}R^{x4}—S—R^{x1}, —S—R^{x1}, wherein R^{x4} is alkylene, R^{x1} is alkyl, and R^{x3} is hydrogen or alkyl as defined herein. In particular embodiments, the term encompasses heteroC₁₋₁₂alkyl, heteroC₁₋₉alkyl and heteroC₁₋₆alkyl. In some embodiments heteroalkyl is selected from the group consisting of alkyloxy, alkyl-oxy-alkyl, (mono or di)alkylamino, (mono or di-)alkyl-amino-alkyl, alkylthio, and alkyl-thio-alkyl.

The term “alkylthio”, as a group or part of a group, refers to a group having the formula —S—R^{x1} wherein R^{x1} is alkyl as defined herein above. Non-limiting examples of alkylthio groups include methylthio (—SCH₃), ethylthio (—SCH₂CH₃), n-propylthio, isopropylthio, n-butylthio, isobutylthio, sec-butylthio, tert-butylthio, and the like.

The term “mono- or di-alkylamino”, as a group or part of a group, refers to a group of formula —N(R^{x3})(R^{x1}) wherein R^{x3} is hydrogen or alkyl as defined herein, and R^{x1} is alkyl as defined herein. Thus, “alkylamino” include mono-alkyl amino group (e.g. mono-alkylamino group such as methylamino and ethylamino), and di-alkylamino group (e.g. di-alkylamino group such as dimethylamino and diethylamino). Non-limiting examples of suitable mono-alkylamino groups include mono-C₁₋₆alkylamino groups such as n-propylamino, isopropylamino, n-butylamino, i-butylamino, sec-butylamino, t-butylamino, pentylamino, n-hexylamino, and the like. Non limiting examples of suitable di-alkylamino groups include di-C₁₋₆alkylamino group such as dimethylamino and diethylamino, di-n-propylamino, di-i-propylamino, ethylmethylamino, methyl-n-propylamino, methyl-propylamino, n-butylmethylamino, i-butylmethylamino, t-butylmethylamino, ethyl-n-propylamino, ethyl-1-propylamino, n-butylethylamino, i-butylethylamino, t-butylethylamino, di-n-butylamino, di-i-butylamino, methylpentylamino, methylhexylamino, ethylpentylamino, ethylhexylamino, propylpentylamino, propylhexylamino, and the like.

The term “nitro” as used herein refers to —NO₂.

The term “amino” refers to the group —NH₂.

The term “cyano” as used herein refers to —CN.

The term “hydroxyl” or “hydroxy”, as a group or part of a group, refers to the group-OH.

Preferred statements (features) and embodiments and uses of this invention are set herein below. Each statement and embodiment of the invention so defined may be combined with any other statement and/or embodiment unless clearly indicated to the contrary. In particular, any feature indicated as being preferred or advantageous may be combined with any other feature or features or statements indicated as being preferred or advantageous. Hereto, the present invention is in particular captured by any one or any combination of one or more of the below numbered statements and embodiments, with any other aspect and/or embodiment.

1. Process for producing hydrogen and carbon dioxide from carbon monoxide and water, comprising the steps of:
a) reacting in a first reaction zone a feed stream comprising carbon monoxide (CO) with water (H₂O) and at least one halogen reactant (X₂) under reaction conditions effective to produce a gaseous CO₂-containing effluent stream and an aqueous solution of hydrogen halide (HX); and,
b) supplying said aqueous solution of hydrogen halide (HX) to a second reaction zone and decomposing said hydrogen halide (HX) under conditions effective to produce a gaseous H₂-rich stream and a stream comprising halogen reactant (X₂).

2. Process according to statement 1, wherein said hydrogen halide is decomposed in step b) by means of electrolysis.

3. Process according to any one of statements 1 to 2, wherein said halogen reactant is selected from the group consisting of bromine (Br₂), chlorine (Cl₂), fluorine (F₂), and iodine (I₂)

4. Process according to any one of statements 1 to 3, wherein said halogen reactant is bromine and said hydrogen halide is hydrogen bromide.

5. Process for producing hydrogen and carbon dioxide from carbon monoxide and water, comprising the steps of:
a) reacting in a first reaction zone a feed stream comprising carbon monoxide (CO) with water (H₂O) and a halogen reactant, wherein said halogen reactant is bromine (Br₂) under reaction conditions effective to produce a gaseous CO₂-containing effluent stream and an aqueous solution of hydrogen bromide (HBr); and,
b) supplying said aqueous solution of hydrogen bromide (HBr) to a second reaction zone and decomposing by means of electrolysis said hydrogen bromide (HBr) under conditions effective to produce a gaseous H₂-rich stream and a stream comprising bromine (Br₂).

6. Process according to any one of statements 1 to 5, further comprising the step of returning the halogen reactant obtained in step b), or a part thereof, to step a) of the process.

7. Process according to any one of statements 1 to 6, wherein steps a) and b) are carried out in separate reaction zones.

8. Process according to any one of statements 1 to 7, wherein the feed stream reacted in step a) comprises at least 5.0 mol % carbon monoxide, such as at least 10.0 mol %, or at least 20.0 mol %, or at least 50.0 mol %, or at least 70.0 mol %, or at least 90.0 mol %, or at least 99.0 mol % of carbon monoxide.

9. Process according to any one of statements 1 to 8, wherein the feed stream comprising carbon monoxide (CO) reacted in step a) is an effluent stream from a CO-generating process.

10. Process according to any one of statements 1 to 9, wherein the feed stream comprising carbon monoxide reacted in step a) is an effluent stream from a process selected from a combustion process of a carbon-containing feedstock; a conversion process of a hydrocarbon-containing feedstock, such as natural gas, mineral oils, or coal; or a coal gasification process.

11. Process according to any one of statements 1 to 10, wherein the feed stream comprising carbon monoxide reacted in step a) comprises a solvent suitable for the dissolution of carbon monoxide in said feed stream.

12. Process according to any one of statements 1 to 11, wherein the feed stream comprising carbon monoxide reacted in step a) comprises an organic solvent, preferably an organic solvent selected from the group consisting of aromatics, aromatic alcohols, alkyl halides, aliphatic amines, aromatic amines, carboxylic acids, ethers, esters, alcohols and organic nitrates.

13. Process according to any one of statements 1 to 12, wherein said water is introduced in said first reaction zone in liquid state.

14. Process according to any one of statements 1 to 12, wherein said water is introduced in said first reaction zone as water vapour.

15. Process according to any one of statements 1 to 14, wherein said feed stream is reacted in step a) at a reaction temperature of at least 40° C., or at least 50° C., or at least 75° C., or at least 100° C., or at least 150° C., or at least 160° C., or at least 180° C., or at least 220° C., or at least 250° C.

16. Process according to any one of statements 1 to 15, wherein said feed stream is reacted in step a) at a reaction temperature of at most 1200° C., such as at most 1000° C., or at most 800° C., or at most 500° C., or at most 350° C., or at most 300° C., or at most 270° C., or at most 250° C., or at most 200° C.

17. Process according to any one of statements 1 to 16, wherein said step a) is carried out at a reaction pressure comprised between 1 and 150 bar, such as between 5 and 100 bar, or between 10 and 80 bar, or between 10 and 50 bar.

18. Process according to any one of statements 1 to 17, wherein step a) of said process is carried out in the absence of a catalyst.

19. Process according to any one of statements 1 to 18, wherein step b) of said process comprises supplying an aqueous solution of hydrogen halide, or hydrogen bromide, to an electrolysis cell containing positive and negative electrodes, and decomposing said hydrogen halide, or hydrogen bromide, electrolytically by maintaining an electrical potential from about 0.5 to 2.5 V between said electrodes, or form 0.5 to 2.5 V.

20. Process according to any one of statements 1 to 19, wherein step b) of said process comprises supplying an aqueous solution of hydrogen halide, or hydrogen bromide, to an electrolysis cell containing positive and negative electrodes, and decomposing said hydrogen halide, or hydrogen bromide, electrolytically by maintaining a current density from about 100 to 800 mA/cm², or from 100 to 800 mA/cm², between said electrodes.

21. Process according to any one of statements 19 to 20, wherein said electrolysis cell is a polymer electrolyte membrane cell (PEM) containing at least a proton-conductive membrane.

22. Process according to any one of statements 1 to 21, wherein said hydrogen halide, or said hydrogen bromide, is decomposed at a temperature of from 20 to 95° C.

23. Process according to any one of statements 1 to 22, wherein said hydrogen halide, or said hydrogen bromide, is decomposed at a pressure of from 1 to 50 bar.

24. Process according to any one of statements 1 to 23, wherein the gaseous CO₂-containing effluent stream obtained in step a) comprises at least 5.0 mol %, such as at least 20.0 mol % of CO₂, or at least 50.0 mol % of CO₂, or at least 90.0 mol % CO₂, or at least 95.0 mol % CO₂, or at least 99.0 mol % CO₂, or at least 99.5 mol % CO₂.

25. Process according to any one of statements 1 to 24, wherein the molar ratio of CO/CO₂ in said gaseous CO₂-containing effluent stream is lower than 0.2, such as lower than 0.1.

26. Process according to any one of statements 1 to 25, wherein said hydrogen-rich stream generated in step b) comprises at least 90.0 mol %, such as at least 95.0 mol %, or at least 99.0 mol %, or at least 99.5 mol %, or at least 99.9 mol % hydrogen.

27. Process according to any of one of statements 1 to 26, for producing hydrogen and carbon dioxide from carbon monoxide and water, comprising the steps of:
a) reacting in a first reaction zone a feed stream comprising carbon monoxide (CO) with water (H₂O) and at least bromine (Br₂) under reaction conditions effective to produce a gaseous CO₂-containing effluent stream and an aqueous solution of hydrogen bromide (HBr); and,
b) supplying said aqueous solution of hydrogen bromide (HBr) to a second reaction zone and decomposing said hydrogen bromide (HBr) under conditions effective to produce a gaseous H₂-rich stream and a stream comprising bromine (Br₂), and wherein said hydrogen bromide is decomposed in step b) by means of electrolysis.

28. Process according to any one of statements 1 to 27, wherein said step b) is carried out in the presence of at least one complexing agent.

29. Process according to statement 28, wherein said complexing agent is an ionic liquid, and wherein said ionic liquid comprises a compound comprising
(i) a halide anion selected from the group consisting of a bromide anion, a chloride anion, a fluoride anion, and an iodide anion, and preferably a bromide anion, and
(ii) an organic cation, wherein said organic cation is a compound having at least one heteroatom selected from the group consisting of N, O, P, and S.

30. Process according to statement 29, wherein said halide anion in said ionic liquid and the halogen atom in the hydrogen halide applied in step b) are the same halogen.

31. Process according to any one of statements 29 to 30, wherein said organic cation in said ionic liquid is selected from the group consisting of imidazolium, imidazolinium, ammonium, aminium, pyridinium, pyrrolidinium, piperidinium, pyridazinium, pyrimidinium, pyrazinium, pyrazolium, pyrazolinium, thiazolium, triazolium, sulfonium, phosphonium, guanidium, isouronium, and isothiouronium cations, and preferably is selected from the group consisting of imidazolium cations.

32. Process according to any one of statements 28 to 31, wherein said complexing agent is selected from the group consisting of 1-butyl-3-methyl-imidazolium bromide, 1-pentyl-3-methyl-imidazolium bromide, 1-hexyl-3-methyl-imidazolium bromide, 1-heptyl-3-methyl-imidazolium bromide, and 1-octyl-3-methyl-imidazolium bromide.

33. Process according to statement 28, wherein said complexing agent comprises at least one nucleophilic heteroatom selected from the group consisting of N, O, P, and S.

34. Process according to statement 28, wherein said complexing agent is an organic compound comprising at least one nucleophilic heteroatom selected from the group consisting of N, O, P, and S, and preferably at least one heteroatom selected from N, O, or S.

35. Process according to statement 28, wherein said complexing agent is an inorganic compound comprising at least one nucleophilic heteroatom selected from the group consisting of N, O, P, and S, and preferably at least one heteroatom selected from N, O, or S.

36. Process according to statement 28, wherein said complexing agent is a heterocyclic organic compound comprising at least one nucleophilic heteroatom selected from the group consisting of N, O, P, and S, and preferably at least one heteroatom selected from N, O, or S.

37. Process according to statement 28, wherein said complexing agent is a dioxane compound, such as selected from 1,3-dioxane, 1,2-dioxane, or 1,4-dioxane.

38. Process according to statement 28, wherein said complexing agent is a compound of formula (II)

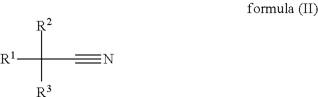

wherein R¹, R², and R³ are each independently selected from hydrogen, halogen, or a group consisting of alkyl, haloalkyl, heteroalkyl, cycloalkyl, heterocyclyl, aryl, heteroaryl, alkyloxy, aryloxy, and cyano,
wherein each of said groups can be unsubstituted or substituted with one or more substituents each independently selected from the group consisting of halogen, nitro, oxo, —C(O)OH, —NH₂, —OH, alkyl, aryl, haloalkyl, heteroalkyl, cycloalkyl, heterocyclyl heteroaryl, alkyloxy, aryloxy, mono-alkylamino, di-alkylamino, alkylthio, and —CN.

39. Process according to statement 28, wherein said complexing agent is a compound of formula (III)

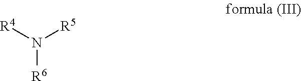

wherein R⁴, R⁵, and R⁶ are each independently selected from hydrogen, halogen, or a group consisting of alkyl, haloalkyl, heteroalkyl, cycloalkyl, heterocyclyl, aryl, heteroaryl, alkyloxy, aryloxy, and cyano,
wherein each of said groups can be unsubstituted or substituted with one or more substituents each independently selected from the group consisting of halogen, nitro, oxo, —C(O)OH, —NH₂, —OH, alkyl, aryl, haloalkyl, heteroalkyl, cycloalkyl, heterocyclyl heteroaryl, alkyloxy, aryloxy, mono-alkylamino, di-alkylamino, alkylthio, and —CN, with the proviso that at least one of R⁴, R⁵, and R⁶ is not hydrogen.

40. Process according to any one of statements 28 to 39, wherein said complexing agent is substantially free of metal, and preferably has a metal concentration which is less than 3000 ppm, or less than 2000 ppm, or less than 1000 ppm, or less than 500 ppm, or less than 250 ppm, or less than 100 ppm, or less than 50 ppm, or less than 10 ppm.

41. Process according to any one of statements 28 to 40, wherein said complexing agent is supplied in step b) as a solution having an amount of complexing agent of from 1.0 to 90.0 wt %, such as from 1.5 to 75.0 wt %, or from 2.0 to 50.0 wt %, or from 2.5 to 35.0 wt %, based on the total weight of said solution.

42. Process according to any of one of the above statements, for producing hydrogen and carbon dioxide from carbon monoxide and water, comprising the steps of:
a) reacting in a first reaction zone a feed stream comprising carbon monoxide (CO) with water (H₂O) and at least one halogen reactant (X₂) under reaction conditions effective to produce a gaseous CO₂-containing effluent stream and an aqueous solution of hydrogen halide (HX); and,
b) supplying said aqueous solution of hydrogen halide (HX) to a second reaction zone and decomposing said hydrogen halide (HX) in the presence of a complexing agent, as defined in any one of the above statements, under conditions effective to produce a gaseous H₂-rich stream and a stream comprising halogen reactant (X₂), wherein said hydrogen halide is preferably decomposed in step b) by means of electrolysis.

43. Process according to any of one of the above statements for producing hydrogen and carbon dioxide from carbon monoxide and water, comprising the steps of:
a) reacting in a first reaction zone a feed stream comprising carbon monoxide (CO) with water (H₂O) and at least bromine (Br₂) under reaction conditions effective to produce a gaseous CO₂-containing effluent stream and an aqueous solution of hydrogen bromide (HBr); and,
b) supplying said aqueous solution of hydrogen bromide (HBr) to a second reaction zone and decomposing said hydrogen bromide (HBr) in the presence of a complexing agent, as defined in any one of the above statements under conditions effective to produce a gaseous H₂-rich stream and a stream comprising bromine (Br₂), wherein said hydrogen bromide is decomposed in step
b) by means of electrolysis.

44. System for producing hydrogen and carbon dioxide from carbon monoxide and water, comprising
at least one first reaction zone configured to react a feed stream comprising carbon monoxide (CO) with water (H₂O) and at least one halogen reactant (X₂), or bromine (Br₂) into a gaseous CO₂-containing effluent stream and an aqueous solution of hydrogen halide (HX), or an aqueous solution of hydrogen bromide (HBr);
at least one second reaction zone, separated from said first reaction zone, and configured to receive an aqueous solution of hydrogen halide, or hydrogen bromide, and to decompose said hydrogen halide, or hydrogen bromide, solution into a gaseous H₂-rich stream and a stream comprising halogen reactant or bromine;
means for supplying a feed stream comprising carbon monoxide to said first reaction zone;
means for supplying water to said first reaction zone;
means for supplying a solution of a halogen reactant, or bromine, to said first reaction zone;
means for separately recovering a gaseous CO₂-containing effluent stream and an aqueous solution of hydrogen halide, or hydrogen bromide, from said first reaction zone;
means for supplying an aqueous solution of hydrogen halide, or hydrogen bromide, recovered from said first reaction zone to said second reaction zone, and
means for separately recovering a gaseous H₂-rich stream and a stream comprising halogen reactant, or bromine, from said second reaction zone.

45. System according to statement 44, further comprising means for returning the stream of halogen reactant, or bromine, or a part thereof, recovered from said second reaction zone to said first reaction zone.

46. System according to any one of statements 44 to 45, wherein said second reaction zone comprises an electrolysis unit comprising at least one electrolysis cell and a power source for supplying current to said electrolysis cell.

47. System according to statement 46, wherein said electrolysis cell is a polymer electrolyte membrane cell (PEM) containing at least a proton-conductive membrane.

48. System according to any one of statements 44 to 47, further comprising means for supplying a complexing agent, preferably as defined in any one of the above statements, to said second reaction zone, preferably to said electrolysis cell.

### Process

The present invention provides a two-step process for performing a water-gas shift reaction. The present invention provides a process for producing a substantially pure stream of hydrogen, and a stream containing carbon dioxide. Such streams of CO₂ and hydrogen are obtained by reacting, in a first step, a feed stream comprising CO with water and at least one halogen reactant, to form reaction products including carbon dioxide and a corresponding hydrogen halide. The hydrogen halide is then decomposed, in a second step, preferably by electrolytic decomposition, to release the hydrogen for recovery and the halogen. The latter may then optionally be recycled in the process.

The two steps of the present process are performed in separate reaction zones. The present invention therefore allows to perform CO oxidation and hydrogen generation in different reaction zones to generate a CO₂ stream ready for capture, and a substantially pure hydrogen stream. The present process may be practiced intermittently as a batch operation or, preferably, as a continuous operation. The second step of the process of the invention involves a decomposition of the produced hydrogen halide, which is preferably accomplished electrolytically.

### Step a)

In a first step of a process according to the invention, a feed stream comprising carbon monoxide (CO) is reacted in a first reaction zone with (i) water (H₂O), and (ii) at least one halogen reactant (X₂), under reaction conditions effective to produce a gaseous CO₂-containing effluent stream and an aqueous solution of hydrogen halide (HX).

More in particular, the present invention provides a process wherein in step a) a feed stream comprising carbon monoxide (CO) is reacted in a first reaction zone with (i) water (H₂O), and (ii) bromine (Br₂), under reaction conditions effective to produce a gaseous CO₂-containing effluent stream and an aqueous solution of hydrogen bromide (HBr).

The term “reaction zone” as used in the present context may refer to an individual reactor or to a reactor system that may comprise one or more reaction zones.

The term “feed stream comprising carbon monoxide (CO)” as used herein may be used as synonym for “feedstock comprising CO” or “CO feedstock” or “CO gas” and intends to refer to a gaseous feed stream comprising carbon monoxide. In some embodiments, carbon monoxide feed stream (gas stream) may contain other constituents or gases such as hydrogen or nitrogen or CO₂.

A feed stream comprising CO reacted in step a) according to the present invention preferably comprise at least 5.0 mol % carbon monoxide, such as at least 10.0 mol %, or at least 20.0 mol %, or at least 50.0 mol %, or at least 70.0 mol %, or at least 90.0 mol %, or at least 99.0 mol % of carbon monoxide.

The feed stream comprising CO for use in the present process may be produced or obtained by any method. Thus, substantially any feed stream containing carbon monoxide provides a suitable source of CO feedstock for use in accordance with the present invention. Preferably such feed stream comprising CO is an effluent stream, e.g. a side stream or waste stream, which was obtained in (another) CO-generating process. In certain embodiments the feed stream comprising carbon monoxide reacted in step a) of the present process is an effluent stream from a combustion process of a carbon-containing feedstock, or from a conversion process of a hydrocarbon-containing feedstock, such as natural gas, mineral oils, or coal, or from a coal gasification process, or from any combination of the foregoing.

In an example, a carbon monoxide feed stream may be obtained from the partial oxidation of carbon-containing compounds.

In another example, a source of CO feedstock may be a gaseous mixture essentially containing carbon monoxide and nitrogen, e.g. formed by combustion of carbon in air at high temperature when there is an excess of carbon. This can be obtained when in an oven, air is passed through a bed of coke. The initially produced CO₂ equilibrates with the remaining hot carbon to give CO. An example of such case could be the regenerator of a fluid catalytic cracking (FCC) unit. FCC is one of conversion processes used in petroleum refineries to convert high-boiling point, high-molecular weight hydrocarbon fractions of petroleum crude oils into more valuable gasoline, olefinic gases, and other products.

In another example, the feed stream comprising CO is “water gas”, i.e. a mixture of hydrogen and carbon monoxide produced via the endothermic reaction of steam and carbon.

In another example, the feed stream comprising CO may be a feed stream obtained during a coal gasification process. During coal gasification, synthesis gas, also termed syngas, comprising hydrogen and carbon oxides (CO and CO₂) may for instance be generated by partial combustion of carbonaceous feedstocks such as coal, petroleum coke or other carbon-rich feedstocks using oxygen or air and steam at elevated temperature and pressure. Such syngas may be a suitable source of feed stream comprising CO for the process of the invention.

Additionally, or alternatively, the CO₂ containing effluent stream obtained in the present process, which may still contain CO, may be re-used as feed stream in step a) of the present process. Hence in an embodiment, the present process further comprises the step of returning the CO₂-containing effluent stream obtained in step b), or a part thereof, to step a) of the process.

Advantageously, the first reaction step of the process of the invention may be performed in the presence of an additive, in particular a solvent, suitable for dissolution of carbon monoxide, to enhance the conversion of carbon monoxide. Suitable solvents for dissolving carbon monoxide include organic solvents. Preferred organic solvents may be selected from the group consisting of aromatics, aromatic alcohols, alkyl halides, aliphatic amines, aromatic amines, carboxylic acids, ethers, esters, alcohols and organic nitrates. Non limiting examples of solvents suitable for use in the present invention include for instance, chloroform, acetic acid, ethyl acetate, ethanol, benzene, toluene, and acetonitrile.

In accordance with the present process, water is introduced in the first reaction zone in liquid state. In another embodiment, water is introduced in the first reaction zone as water vapour (steam). Preferably, water is introduced directly into the reaction zone. In other words, in a preferred embodiment of the present process, water is added to the first reaction zone separately from the CO-comprising feed stream.

The halogen reactant applied in the first step of the present process may be selected from the group consisting of bromine (Br₂), chlorine (Cl₂), fluorine (F₂), and iodine (I₂), and preferably is bromine. Preferably, the halogen reactant, preferably bromine, is introduced directly into the (first) reaction zone. The halogen reactant, preferably bromine, may be introduced in the reaction zone in liquid state. The halogen reactant, preferably bromine, may be introduced in the reaction zone in pure form, or dissolved in an aqueous hydrogen halide solution. The time required for the CO feedstock, water, and halogen, preferably bromine, to react will vary depending on the specific feed material utilized, the halogen utilized, and the temperature of the reaction.

The present invention provides a process for producing hydrogen and carbon dioxide from carbon monoxide and water, comprising the steps of:
a) reacting in a first reaction zone a feed stream comprising carbon monoxide (CO) with water (H₂O) and a halogen reactant, wherein said halogen reactant is bromine (Br₂) under reaction conditions effective to produce a gaseous CO₂-containing effluent stream and an aqueous solution of hydrogen bromide (HBr); and,
b) supplying said aqueous solution of hydrogen bromide (HBr) to a second reaction zone and decomposing by means of electrolysis said hydrogen bromide (HBr) under conditions effective to produce a gaseous H₂-rich stream and a stream comprising bromine (Br₂).

In accordance with the present process, the CO feed stream is reacted in step a) at a reaction temperature of at least 40° C., such as at least 50° C., or at least 75° C., or at least 100° C., or at least 150° C., or at least 160° C., or at least 180° C., or at least 220° C., or at least 250° C. Further in accordance with the present process, the CO feed stream is reacted in step a) at a reaction temperature of at most 1200° C., such as at most 1000° C., or at most 850° C., or at most 500° C., or at most 350° C., or at most 300° C., or at most 270° C., or at most 250° C., or at most 200° C. For instance, preferred temperature conditions for the reaction between the feed stream comprising CO, water, and halogen in the present process are comprised between 40 and 1200° C., or between 5° and 1200° C., or between 10° and 1200° C., or between 10° and 800° C., or between 18° and 800° C., or between 22° and 800° C.

In accordance with the present process, step a) of the process is carried out at a reaction pressure comprised between 1 and 150 bar (0.1-15 MPa), such as between 5 and 100 bar (0.5-10 MPa), or between 10 and 80 bar (1-8 MPa), or between 10 and 50 bar (1-5 MPa).

In certain preferred embodiments, a temperature within the range of from 160 to 270° C., and a pressure of from 20 and 35 bar have been found particularly satisfactory for carrying out step a) of the present process.

In certain embodiments of the present process the feed stream comprising CO and the halogen reactant are applied at a molar ratio of CO/halogen in said first reaction zone comprised between 0.01 and 0.9.

The process of the invention is further characterised in that step a) of said process is carried out in the absence of a catalyst.

Step a) of a process according to the present invention yields a gaseous effluent stream comprising CO₂, and an aqueous solution of hydrogen halide (HX). Preferably, the gaseous effluent stream comprising CO₂, herein also denoted as “CO₂-containing effluent stream”, comprises least 5.0 mol % carbon monoxide, such as at least 10.0 mol %, or at least 20.0 mol %, or at least 50.0 mol %, or at least 60.0 mol %, or at least 70.0 mol %, or at least 80.0 mol %, or at least 90.0 mol %, or at least 95.0 mol %, or at least 99.0 mol % of carbon monoxide.

In certain embodiments of the present invention, the process may comprise a further step of concentrating the CO₂-containing effluent stream. In accordance with the invention, the CO₂-containing effluent stream obtained in step a) may be treated by any method known in the art in order to obtain concentrated CO₂ stream. Suitable methods include but are not limited to e.g. absorption in ethanolamine and potassium hydroxide (KOH).

In certain preferred embodiments, the CO₂-containing effluent stream obtained in the present process contains less than 5.0 mol %, such as less than 2.0 mol %, or less than 1.0 mol %, or less than 0.5 mol %, or less than 0.1 mol %, or less than 0.01 mol % of CO.

In certain preferred embodiments, the molar ratio of CO/CO₂ in said gaseous CO₂-containing effluent stream is lower than 0.2, such as lower than 0.1, or lower than 0.05, or lower than 0.01. In an example, CO/CO₂ molar ratio in said gaseous CO₂-containing effluent stream is comprised between 0 and 0.2, or between 0 and 0.1, or between 0 and 0.05, or between 0 and 0.01.

In a preferred example, the CO₂-containing effluent stream reaction gas is free of carbon monoxide, i.e. the CO₂-containing effluent stream does not contain (detectable) CO.

### Step b)

The aqueous solution of hydrogen halide obtained in step a) of the process is then subject to decomposition to release the hydrogen for recovery and halogen. Said halogen may be recycled to the first step for reaction with additional CO-comprising feed stream.

The preferred mode of hydrogen halide decomposition is electrolytic. Thus, the second step of a process of the invention preferably takes place in an electrolysis cell, preferably in a polymer electrolyte membrane cell (PEM) containing at least a proton-conductive membrane. Polymer electrolyte membrane (PEM) electrolysis is well known in the art an involves a cell equipped with a solid polymer electrolyte (SPE) that is responsible for the conduction of protons, separation of product gases, and electrical insulation of the electrodes.

More in particular, the present invention provides a process wherein in step b) the aqueous solution of hydrogen bromide (HBr) (obtained in step a)) is supplied to a second reaction zone and decomposed by means of electrolysis under conditions effective to produce a gaseous H₂-rich stream and a stream comprising bromine (Br₂).

In accordance with the present process, it can be understood that step b) of the process is carried out under aqueous conditions.

In some embodiments of the invention, step b) of the present process comprises the step of supplying an aqueous solution of hydrogen halide, such as hydrogen bromide, to an electrolysis cell (as defined herein) containing positive and negative electrodes, and decomposing said hydrogen halide such as hydrogen bromide, electrolytically by maintaining an electrical potential from 0.5 to 2.5 V between said electrodes.

In some embodiments of the invention, step b) of the present process comprises the step of supplying an aqueous solution of hydrogen halide, such as hydrogen bromide, to an electrolysis cell (as defined herein) containing positive and negative electrodes, and decomposing said hydrogen halide, such as hydrogen bromide, electrolytically by maintaining a current density from 100 to 800 mA/cm² between said electrodes.

The electrical potential required to decompose the hydrogen halide solution, such as hydrogen bromide solution, decreases as the temperature of the aqueous solution increases. It is particularly preferred to practice the electrolytic decomposition at a temperature of from 20 to 95° C., and preferably from 40 to 80° C. The pressure in the electrolytic decomposition zone is maintained sufficiently high to maintain the aqueous hydrogen halide (hydrogen bromide) in a liquid phase. Generally the pressure will be within a range from 0.1 to 5 MPa (1-50 bar).

In certain embodiments of the present invention, a process is provided wherein step b) of the process is carried out in the presence of at least one complexing agent. A complexing agent as used in the present process intends to refer to a compound that is capable of forming a complex with the halogen reactant, such as bromine, formed in the electrolytical cell. For instance, a bromine-complexing agent combines with bromine molecule(s) to form a poly-bromide complex.

The complexing agent for use in the present process of the invention is preferably a compound as further defined herein below.

The present invention thus provides in certain embodiments a process as defined above, wherein step b) involves supplying an aqueous solution of hydrogen halide (HX) to a second reaction zone and decomposing said hydrogen halide (HX) under conditions effective to produce a gaseous H₂-rich stream and a stream comprising halogen reactant (X₂), wherein said decomposition is carried out in the presence of at least complexing agent as defined herein, and preferably wherein said hydrogen halide is decomposed in step b) by means of electrolysis.

In certain embodiments, a process is herein provided for producing hydrogen and carbon dioxide from carbon monoxide and water, comprising the steps of:
a. reacting in a first reaction zone a feed stream comprising carbon monoxide (CO) with water (H₂O) and at least one halogen reactant (X₂) under reaction conditions effective to produce a gaseous CO₂-containing effluent stream and an aqueous solution of hydrogen halide (HX); and,
b. supplying said aqueous solution of hydrogen halide (HX) to a second reaction zone and decomposing said hydrogen halide (HX) in the presence of at least one complexing agent as defined herein, under conditions effective to produce a gaseous H₂-rich stream and a stream comprising halogen reactant (X₂), preferably wherein said hydrogen halide is decomposed in step b) by means of electrolysis.

In certain embodiments, a process is herein provided for producing hydrogen and carbon dioxide from carbon monoxide and water, comprising the steps of:
a. reacting in a first reaction zone a feed stream comprising carbon monoxide (CO) with water (H₂O) and bromine (Br₂) under reaction conditions effective to produce a gaseous CO₂-containing effluent stream and an aqueous solution of hydrogen bromide (HBr); and,
b. supplying said aqueous solution of hydrogen bromide (HBr) to a second reaction zone and decomposing said hydrogen bromide (HBr) in the presence of at least one complexing agent as defined herein, under conditions effective to produce a gaseous H₂-rich stream and a stream comprising bromine (Br₂), wherein said hydrogen bromide is decomposed in step b) by means of electrolysis.

In certain embodiments of the present process the “at least one complexing agent” as used in the present process, in particular in step b) of the present process, is an ionic liquid.

Preferably, ionic liquids used as complexing agent in the present process, in particular in step b) of the present process, comprise, and preferably consist of,
a halide anion, and
an organic compound as cation, i.e. an organic cation. In particular, such organic cation (organic compound) is a compound that has at least one heteroatom selected from the group consisting of N, O, P, and S.

The halide anions associated with ILs can also be structurally diverse and can have a significant impact on the solubility of the ILs in different media. ILs containing hydrophilic anions such as chloride are completely miscible in water.

In accordance with the present invention, said ionic liquid contains a (negatively charged) halide anion. Said halide anion in said ionic liquid may be selected from the group consisting of a bromide anion, a chloride anion, a fluoride anion, and an iodide anion. In certain preferred embodiments, said halide anion in said ionic liquid is a bromide anion.

In certain embodiments of the present invention, the halide anion applied in said ionic liquid, e.g. a bromide anion, and the halogen atom applied in the hydrogen halide solution, i.e. the aqueous solution of hydrogen halide supplied in step b) of the present method, are the same halogen, for instance bromine.

In certain embodiments, said organic cation contains one or more nitrogen atoms that are part of a ring structure and can be converted to a quaternary ammonium. Examples of these cations include pyridinium, pyridazinium, pyrimidinium, pyrazinium, imidazolium, pyrazolium, oxazolium, triazolium, thiazolium, piperidinium, pyrrolidinium, quinolinium, and isoquinolinium.

In certain embodiments of the present process, an ionic liquid is applied wherein said organic cation is selected from the group consisting of imidazolium, imidazolinium, ammonium, aminium, pyridinium, pyrrolidinium, piperidinium, pyridazinium, pyrimidinium, pyrazinium, pyrazolium, pyrazolinium, thiazolium, triazolium, sulfonium, phosphonium, guanidium, isouronium, and isothiouronium cations.

Suitable examples of organic cations include but are not limited to for instance 1-butyl-3-methyl-imidazolium, 2,3-dimethyl-1-butyl-imidazolium, 1,3-diethoxyimidazolium, 1,3-dihydroxyimidazolium, 1-benzyl-3-methyl-imidazolium, 1-methyloxymethyl-3-methyl-imidazolium, 1-methyl-3-propylimidazolium, 1,2-dimethyl-3-propylimidazolium, 1-pentyl-3-methyl-imidazolium, 1-methyl-3-(3,3,4,4,5,5,6,6,6-nonafluorohexyl) imidazolium, 1-heptyl-3-methyl-imidazolium, 1-decyl-3-methyl-imidazolium, 1-ethyl-3-methyl-imidazolium, 1,2-dimethyl-3-ethyl-imidazolium, N-heptyl-N-methylpyrrolidinium, 1-methyl-3-(3,3,4,4,5,5,6,6,7,7,8,8,8-tridecafluorooctyl) imidazolium, 1-butyronitrile-3-methyl-imidazolium, 1-butyronitrile-2,3-dimethyl-imidazolium, 1-(2-hydroxyethyl)-3-methyl-imidazolium, 1-hexyl-3-methyl-imidazolium, 2,3-dimethyl-1-hexyl-imidazolium, 1,3-dimethyl-imidazolium, 1-hydroxy-propyl-3-methylimidazolium, 1-nonyl-3-methyl-imidazolium, 1-octyl-3-methyl-imidazolium, 1-butyl-2-methyl-pyridinium, 1-benzyl-2-methyl-pyridinium, 1-butyl-3-methyl-pyridinium, 1-benzyl-3-methyl-pyridinium, 1-octyl-3-methyl-pyridinium, 1-benzyl-4-methyl-pyridinium, 1-butyl-nicotinic acid butyl ester, bis(2-hydroxyethyl) ammonium, 1-butyl-4-methyl-pyridinium, 1-butyl-1-methyl-pyrrolidinium, butylpyridinium, 1-benzyl-1-methyl-pyrrolidinium, 1-benzyl-4-methyl-pyridinium, 1-propyl-3-methyl-pyridinium, N-propyl-N-methyl-pyrrolidinium, N-pentyl-N-methyl-pyrrolidinium, 2-hydroxyethyltrimethylammonium, N,N-dimethylformamide, 1-ethyl-4-methyl-pyridinium, ethyl-pyridinium, S-Ethyl-N,N,N′,N′-tetramethylisothiouronium, guanidinium, monoethanolaminium, 2-hydroxyethanaminium, 2-hydroxy-N-(2-hydroxyethyl)-N-methylethanaminium, 1-hexyl-3-methylpyridinium, 1-hexyl-1-methylpyrrolidinium, hexylpyridinium, N-methyl-2-hydroxyethylammonium, [2-(methacryloyloxy)ethyl]trimethylammonium, 2-[2-hydroxyethyl (methyl) amino]ethanol, monoethanolaminium, choline, methyltrioctylammonium, ethyldimethylpropylammonium, N,N,N,N-trimethylbutylammonium, methyl-tributylammonium, tetrabutylammonium, N-nonyl-triisobutyl-methyl-phosphonium, N-methyl-pyrrolidinium, 1-octyl-1-methyl-pyrrolidinium, tertra-N-butylphosphonium, tributyl(tetradecyl)phosphonium, trihexyl(tetradecyl)phosphonium, N-(2-hydroxyethyl)pyridinium, tri-(2-hydroxy-ethyl)-ammonium, 1,1,3,3-tetramethyl-guanidium, (p-Vinylbenzyl)trimethyl-ammonium, tetraethylammonium, tetramethylammonium, pyrrolidinium, and tributylsulfonium.

In certain embodiments of the present process, an ionic liquid is applied wherein said organic cation is selected from the group consisting of imidazolium, ammonium, aminium, pyridinium, pyrrolidinium, phosphonium, guanidium, and isothiouronium cations.

In certain embodiments of the present process, particular preference is given to ionic liquids with an imidazolium cation.

In certain preferred embodiments, said organic cation is selected from the group consisting of an imidazolium cation of formula (I):

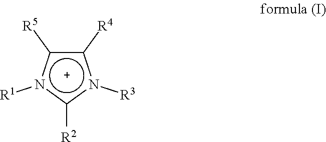

wherein each of R¹, R², R³, R⁴ and R⁵ is independently selected from hydrogen, or a group consisting of hydroxyl, alkyl, haloalkyl, heteroalkyl, heterocyclyl, cycloalkyl, alkyloxy, alkyloxyalkyl, aryl, heteroaryl, and aryloxy, and wherein each of said groups can be unsubstituted or substituted with one or more substituents each independently selected from the group consisting of halogen, nitro, oxo, —C(O)OH, amino hydroxyl, alkyl, aryl, alkyloxy, aryloxy, mono-alkylamino, di-alkylamino, alkylthio, and cyano.

In certain preferred embodiments, said organic cation is selected from the group consisting of an imidazolium cation of general formula (I) wherein each of R¹, R², R³, R⁴ and R⁵ is independently selected from hydrogen or from the group consisting of alkyl, cycloalkyl, alkyloxy, alkyloxyalkyl, aryl, and aryloxy group, wherein each of said groups can be unsubstituted or substituted with one or more substituents each independently selected from the group consisting of halogen, nitro, oxo, —C(O)OH, amino hydroxyl, alkyl, aryl, alkyloxy, aryloxy, mono-alkylamino, di-alkylamino, alkylthio, and cyano.

In certain preferred embodiments, said organic cation is selected from the group consisting of an imidazolium cation of general formula (I) wherein each of R¹, R², R³, R⁴ and R⁵ is independently selected from hydrogen or from the group consisting of alkyl or an aryl group, wherein each of said groups can be unsubstituted or substituted with one or more substituents each independently selected from the group consisting of halogen, nitro, oxo, —C(O)OH, amino, hydroxyl, alkyl, aryl, alkyloxy, aryloxy, mono-alkylamino, di-alkylamino, alkylthio, and cyano.

In certain embodiments, said organic cation is selected from the group consisting of an imidazolium cation of general formula (I) wherein R², R⁴ and R⁵ are hydrogen and R¹ and R³, are each independently selected from hydrogen or from the group consisting of hydroxyl, alkyl, haloalkyl, heteroalkyl, heterocyclyl, cycloalkyl, alkyloxy, alkyloxyalkyl, aryl, heteroaryl, and aryloxy, and wherein each of said groups can be unsubstituted or substituted with one or more substituents each independently selected from the group consisting of halogen, nitro, oxo, —C(O)OH, amino, hydroxyl, alkyl, aryl, alkyloxy, aryloxy, mono-alkylamino, di-alkylamino, alkylthio, and cyano.

In certain preferred embodiments, said organic cation is selected from the group consisting of an imidazolium cation of formula (I), wherein each of R¹ and R³ is independently selected from alkyl, wherein said alkyl group is optionally substituted with one or more substituents each independently selected from the group consisting of halogen, nitro, oxo, —C(O)OH, amino, hydroxyl, alkyl, aryl, alkyloxy, aryloxy, mono-alkylamino, di-alkylamino, alkylthio, and cyano.

Suitable imidazolium cations for use in an ionic liquid as applied in the present process may be selected from the group consisting of 1-butyl-3-methyl-imidazolium, 2,3-dimethyl-1-butyl-imidazolium, 1,3-diethoxyimidazolium, 1,3-dihydroxyimidazolium, 1-benzyl-3-methyl-imidazolium, 1-methyloxymethyl-3-methyl-imidazolium, 1-methyl-3-propyl-imidazolium, 1,2-dimethyl-3-propyl-imidazolium, 1-pentyl-3-methyl-imidazolium, 1-methyl-3-(3,3,4,4,5,5,6,6,6-nonafluorohexyl) imidazolium, 1-heptyl-3-methyl-imidazolium, 1-decyl-3-methyl-imidazolium, 1-ethyl-3-methyl-imidazolium, 1,2-dimethyl-3-ethyl-imidazolium, 1-methyl-3-(3,3,4,4,5,5,6,6,7,7,8,8,8-tridecafluorooctyl) imidazolium, 1-butyronitrile-3-methyl-imidazolium, 1-butyronitrile-2,3-dimethyl-imidazolium, 1-(2-hydroxyethyl)-3-methyl-imidazolium, 1-hexyl-3-methyl-imidazolium, 2,3-dimethyl-1-hexyl-imidazolium, 1,3-dimethyl-imidazolium, 1-hydroxy-propyl-3-methylimidazolium, 1-nonyl-3-methyl-imidazolium, and 1-octyl-3-methyl-imidazolium.

Particularly suitable examples of complexing agent used in the present process may for instance include 1-butyl-3-methyl-imidazolium bromide, 1-ethyl-3-methyl-imidazolium bromide, 1-propyl-3-methyl-imidazolium bromide, 1-pentyl-3-methyl-imidazolium bromide, 1-hexyl-3-methyl-imidazolium bromide, 1-heptyl-3-methyl-imidazolium bromide, and 1-octyl-3-methyl-imidazolium bromide.

In certain embodiments, a process is herein provided for producing hydrogen and carbon dioxide from carbon monoxide and water, comprising the steps of:
a. reacting in a first reaction zone a feed stream comprising carbon monoxide (CO) with water (H₂O) and bromine (Br₂) under reaction conditions effective to produce a gaseous CO₂-containing effluent stream and an aqueous solution of hydrogen bromide (HBr); and,
b. supplying said aqueous solution of hydrogen bromide (HBr) to a second reaction zone and decomposing said hydrogen bromide (HBr) in the presence of at least one complexing agent, wherein said complexing agent is an ionic liquid, wherein said ionic liquid comprises, preferably consists of, a compound comprising a bromide anion and an imidazolium cation, such as an imidazolium cation of formula (I) as defined herein above, under conditions effective to produce a gaseous H₂-rich stream and a stream comprising bromine (Br₂), wherein said hydrogen bromide is decomposed in step b) by means of electrolysis.

Complexing agents, for use in the present process involve compounds that are “capable of forming a halogen bond” with the halogen formed during the process.

The term “halogen bond” refers to a bond occurring when “there is evidence of a net attractive interaction between an electrophilic region associated with a halogen atom in a molecular entity and a nucleophilic region in another, or the same, molecular entity.” Halogen bonding is a noncovalent interaction. In the context of the present invention, the “halogen bond” refers to the interaction that take places between the electrophilic region in the halogen that is formed during the electrolysis process, and a nucleophilic region in the complexing agent. Hence, for the purpose of the present invention, the term “halogen bond” indicates a non-covalent interaction involving the halogen formed during the process (e.g. fluorine (F₂), chlorine (Cl₂), bromine (Br₂), or iodine (I₂)), which acts as an electrophilic part, and the nucleophilic region (e.g. a nucleophilic heteroatom, e.g. N, P, S or O) in the complexing agent.

A halogen bond between a halogen (such as Br₂) and the complexing agent can be represented and defined in the present invention as follows:

R-A . . . X-X

wherein A represents the halogen bond acceptor (an electron density donor), herein a heteroatom of the complexing agent (e.g. N, P, S or O), and X is the halogen derivative, herein F, Cl, Br, I, or At, preferably Br.

The halogen bond may be characterised through two geometrical properties. The first is the A - - - X halogen bond distance between A and X. The distance A - - - X is typically smaller than the sum of the van der Waals radii of corresponding atoms. The second is the directionality, defined by the angle A-X-X, which is about 180°, preferably more than 160°.

The halogen bond can be detected by an XRD analysis, determining positions of atoms in the structure of the compound, for instance, by single-crystal XRD. These techniques are known to the skilled person.

In certain preferred embodiments, a complexing agent for use in the present process is a compound that comprises at least one nucleophilic heteroatom selected from the group consisting of N, O, P, and S, and preferably selected from N, O or S.

In certain embodiments, a complexing agent for use in the present process is an organic compound comprising at least one nucleophilic heteroatom selected from the group consisting of N, O, P, and S, and preferably at least one heteroatom selected from N, O, or S, or at least one heteroatom selection from N or O.

In certain embodiments, a complexing agent for use in the present process is an inorganic compound comprising at least one nucleophilic heteroatom selected from the group consisting of N, O, P, and S, and preferably at least one heteroatom selected from N, O, or S, or at least one heteroatom selection from N or O.

As used herein, the term “heteroatom” refers to a non-carbon atom. The term “nucleophilic”, such as in “nucleophilic (hetero) atom” refers to a (hetero) atom that forms bonds (with electrophilic species, i.e. species accepting an electron pair such as e.g. the halogen formed during the present process) by donating an electron pair. Suitable “nucleophilic heteroatoms” according to the present invention include nitrogen atoms, oxygen atoms, sulfur atoms and phosphorus atoms. In certain embodiments, “nucleophilic heteroatoms” according to the present invention include at least one heteroatom selected from group the consisting of N, O, and S, or preferably at least one heteroatom selected from N or O.

In some embodiments, the complexing agent as applied in the process of the invention is a heterocyclic organic compound comprising at least one nucleophilic heteroatom selected from the group consisting of N, O, P, and S, and preferably at least one heteroatom selected from N, O, or S.

Non-limiting examples of heterocyclic organic compounds comprising at least one nucleophilic heteroatom selected from the group consisting of N, O, P, and S include for instance, dioxane compounds such as 1,3-dioxane, 1,2-dioxane, 1,4-dioxane, tetrahydrofuran (THF), pyridine, 2-ethylpyridine, 4,4′-bipyridine, 2-methypyridine (2-picoline), 2,6-dimethylpyridine (2,6-lutidine), 2,4,6-collidine, qinoline, piperidine, N-methylpiperidine, morpholine, N-methylmorpholine, thiomorpholine, tetrahydrothiophene, N,N,N-dimethylpyridin-4-amine, acridine, triethylphosphine, and the like.

In some embodiments, the complexing agent as applied in the process of the invention is a compound of formula (II)

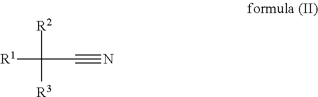

wherein R¹, R², and R³ are each independently selected from hydrogen, halogen, or a group consisting of alkyl, haloalkyl, heteroalkyl, cycloalkyl, heterocyclyl, aryl, heteroaryl, alkyloxy, aryloxy, and cyano, wherein each of said groups can be unsubstituted or substituted with one or more substituents each independently selected from the group consisting of halogen, nitro, oxo, —C(O)OH, amino (—NH₂), hydroxyl (—OH), alkyl, aryl, haloalkyl, heteroalkyl, cycloalkyl, heterocyclyl heteroaryl, alkyloxy, aryloxy, mono-alkylamino, di-alkylamino, alkylthio and cyano (—CN).

In some embodiments, the complexing agent as applied in the process of the invention is a compound of formula (III)

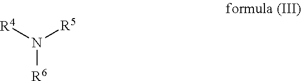

wherein R⁴, R⁵, and R⁶ are each independently selected from hydrogen, halogen, or a group consisting of alkyl, haloalkyl, heteroalkyl, cycloalkyl, heterocyclyl, aryl, heteroaryl, alkyloxy, aryloxy, and cyano, wherein each of said groups can be unsubstituted or substituted with one or more substituents each independently selected from the group consisting of halogen, nitro, oxo, —C(O)OH, amino (—NH₂), hydroxyl (—OH), alkyl, aryl, haloalkyl, heteroalkyl, cycloalkyl, heterocyclyl heteroaryl, alkyloxy, aryloxy, mono-alkylamino, di-alkylamino, alkylthio, and cyano (—CN), and with the proviso that at least one of R⁴, R⁵, and R⁶ is not hydrogen.

Non-limiting examples of complexing agents having formula (II) for use in the present process may for instance be selected from the list comprising acetonitrile, 4-chlorobutyronitrile, acetamiprid, acetothiolutamide, acetyl cyanide, acrylonitrile, adiponitrile, alectinib, allyl cyanide, almokalant, alogliptin, amfetaminil, aminoacetonitrile, aminopropionitrile, anagliptin, anastrozole, anipamil, apalutamide, 3-arylpropiolonitriles, 4,4′-azobis(4-cyanopentanoic acid), bazinaprine, benfotiamine, benzyl cyanide, bezitramide, bicyclo(2.2.1) heptane-2-carbonitrile, bimakalim, bromobenzyl cyanide, bromoxynil, butyronitrile, cacodyl cyanide, calyculin, carbonyl cyanide m-chlorophenyl hydrazone, carbonyl cyanide-p-trifluoromethoxyphenylhydrazone, cefacetrile, cefmetazole, chlorfenapyr, chloroacetonitrile, 3-chloropropionitrile, chlorothalonil, cianopramine, cicortonide, cilomilast, cimetidine, cinolazepam, crisaborole, cromakalim, cyamemazine, 4-cyano-3-(trifluoromethyl) aniline, 4-cyano-4′-pentylbiphenyl, cyanoacetamide, cyanoacetic acid, cyanoalanine, cyanocarbon, cyanodothiepin, cyanoform, cyanoketone, cyanomethyl, cyanonilutamide, cyanophos, cyanophosphaethyne, cyanopindolol, cyanopolyyne, cyantraniliprole, cyazofamid, cyclopropyl cyanide, dapagliflozin, dapansutrile, darolutamide, delgocitinib, N-desmethylapalutamide, desmethylcitalopram, N-desmethylenzalutamide, devapamil, diaminomaleonitrile, diarylpropionitrile, 2,3-dichloro-5,6-dicyano-1,4-benzoquinone, diclazuril, dicyanamide, didesmethylcitalopram, dienogest, difenoxin, diphenoxylate, doravirine, emopamil, endothion, enobosarm, entacapone, enzalutamide, epanolol, epostane, escitalopram, esfenvalerate, ethyl cyanoacetate, ethyl cyanohydroxyiminoacetate, etravirine, fadrozole, febuxostat, fenproporex, fenvalerate, finafloxacin, finerenone, finrozole, flonicamid, fluvalinate, formyl cyanide, fosdevirine, fosravuconazole, 2-furonitrile, gallopamil, glasdegib, glutaronitrile, hydromelonic acid, ibrolipim, iodocyanopindolol, ironomycin, isavuconazonium, isoaminile, isobutyronitrile, ketodarolutamide, lecozotan, leflutrozole, lergotrile, levocabastine, levosimendan, lodoxamide, lugduname, luliconazole, malononitrile, 3-mercaptopropionitrile, metaflumizone, methacrylonitrile, methyl cyanoformate, 5-methyl-2-((2-nitrophenyl)amino)-3-thiophenecarbonitrile, methyldibromo glutaronitrile, 2-methyleneglutaronitrile, 2-methylglutaronitrile, momelotinib, nafadotride, neratinib, 2,2′,2″-nitrilotriacetonitrile, nitroxinil, norverapamil, odanacatib, osilodrostat, ozanimod, pacrinolol, pentacyanocyclopentadiene, pentanenitrile, perampanel, phoxim, piritramide, pivalonitrile, pradofloxacin, prexasertib, propionitrile, proxalutamide, pyriprole, ranelic acid, ravuconazole, remdesivir, and ricinine.

Preferred complexing agents having formula (II) for use in the present process include for instance acetonitrile, ethyl cyanide, aminoacetonitrile, bromoacetonitrile, chloroacetonitrile, 2,2′,2″-nitrilotriacetonitrile, and the like.

Non-limiting examples of complexing agents having formula (III) for use in the present process may for instance be selected from the list comprising methylamine, ethylamine, propylamine, butylamine, pentylamine, hexylamine, heptylamine, octylamine, 2-ethylhexylamine, triethylamine, nonylamine, decylamine, undecylamine, dodecylamine, tridecylamine, tetradecylamine, pentadecylamine, hexadecylamine, heptadecylamine, octadecylamine, nonadecylamine, eicosylamine, dimethylamine, diethylamine, dipropylamine, dibutylamine, dipentylamine, diisobutylamine, di-tert-butylamine, dipentylamine, dihexylamine, diheptylamine, dioctylamine, di(2-ethylhexylamine), dinonylamine, didecylamine, thimethylamine, triethylamine, tripropylamine, tripropyl amine, triisopropylamine, tributylamine, tripentylamine, trihexylamine, triheptylamine, trioctylamine, trinonylamine, tridecylamine, cyclopentylamine, methylcyclopentylamine, ethylcyclopentylamine, propylcycplopentylamine, butylcyclopentylamine, dicyclohexylamine, N,N-Dicyclohexylmethylamine, etc. Examples of polyamines are triethylenetetramine, tetraethylenepentamine, pentaethylenehexamine, dipropylenetriamine, tripropylenetetramine, tetrapropylenepentamine, dibutylenetriamine, tributylenetettamine, tetrabutylenepentamine, N,N-dipropylmethylenediamine, N,N-dipropylethylene-1,2-diamine, N,N-diethylpropylene-1,3-diamine, N,N-dipropylpropylene-1,3-diamine, N,N-diethylbutylene-1,4-diamine, N,N-dipropylbutylene-1,4-diamine, N,N-dimethylpentylene-1,3-diamine, N,N-diethylpentylene-1,5-diamine, N,N-dipropylpentylene-1,5-diamine, N,N-dimethylhexylene-1,6-diamine, N,N-diethylhexylene-1,6-diamine, N,N-dipropylhexylene-1,6-diamine, bis[2-(N,N-dimethyl-amino)ethyl]amine, bis[2-(N,N-dipropylamino)ethyl]amine, bis[3-(N,N-dimethylamino)propyl]amine, bis[3-(N,N-diethylamino)-propyl]amine, bis[3-(N,N-dipropylamino)propyl]amine, bis[4-(N,N-dimethylamino)butyl]amine, bis[4-(N,N-diethylamino)butyl]amine, bis[4-(N,N-dipropylamino)butyl]amine, bis[5-(N,N-dimethylamino)-pentyl]amine, bis[5-(N,N-diethylamino)pentyl]amine, bis[5-(N,N-dipropylamino)pentyl]amine, bis[6-(N,N-dimethylamino)-hexyl]amine, bis[6-(N,N-diethylamino)hexyl]amine, bis[6-(N,N-tris[2-(N,N-dimethyl-amino)ethyl]amine, tris[2-(N,N-dipropylamino)hexyl]amine, dipropylamino)ethyl]amine, tris[3-(N,N-dimethylamino)propyl]amine, tris[3-(N,N-diethyl-amino)propyl]amine, tris[3-(N,N-dipropylamino)propyl]amine, tris[4-(N,N-dimethylamino)butyl]amine, tris[4-(N,N-diethylamino)-butyl]amine, tris[4-(N,N-dipropylamino)butyl]amine, tris[5-(N,N-dimethylamino)pentyl]amine, tris(5-(N,N-diethyl-amino)pentyl]amine, tris[5-(N,N-dipropylamino)pentyl]amine, tris[6-(N,N-dimethylamino)hexyl]amine, tris[6-(N,N-diethylamino)-hexyl]amine, tris[6-(N,N-dipropylamino), hexyl]amine.

Preferred complexing agents having formula (III) for use in the present process include for instance N,N-dimethylpropylamine, aniline, 4-alkoxyaniline, 3-nitroaniline, 4-nitroaniline, 4-trifluoromethylaniline, and N,N,N′,N′-tetra-alkyl-p-phenylenediamine.

A complexing agent as applied in the present process is preferably substantially free of metal, or preferably is free of metal. “Metals” as used in this context refers to metals selected from the group consisting of transition metals, alkali metals and alkaline earth metals. The term metals also encompasses compounds of metal thereof, e.g. metal oxides. In the present invention, the term “transition metal” as used herein refers to any element in the d-block of the periodic table, including the elements of the 3rd to 12th group of the periodic table. The term “transition metal” further includes any element in the f-block of the periodic table, including the elements of the lanthanide and actinide series. In the present invention, the term “alkali metal” as used refers to any element in group 1 excluding hydrogen in the periodic table, including lithium (Li), sodium (Na), potassium (K), rubidium (Rb), caesium (Cs), and francium (Fr). In the present invention, the term “alkaline-earth metal” as used refers to any element in group 2 in the periodic table, including beryllium (Be), magnesium (Mg), calcium (Ca), strontium (Sr), barium (Ba) and radium (Ra).

“Substantially free of metal” or “substantially metal-free” as used herein refers to a complexing agent as defined herein that has a concentration of metal (as defined herein above) which is less than 3000 ppm, or less than 2000 ppm, or less than 1000 ppm, or less than 500 ppm, or less than 250 ppm, or less than 100 ppm, or less than 50 ppm, or less than 10 ppm.

Metal content of a complexing agent as provided herein may be determined by techniques known in the art such as atomic absorption spectroscopy (AAS) or other elemental analysis technique, such as x-ray photoelectron spectroscopy (XPS), or mass spectrometry (e.g., inductively coupled plasma mass spectrometry, or “ICP-MS”) or X-ray fluorescence (XRF).

In certain preferred embodiments of the present invention, the complexing agent as defined herein is free of any metal (as defined herein above).

The complexing agent is preferably supplied as a solution, and preferably as a solution having an amount of complexing agent of from 1.0 to 90.0 wt %, such as from 1.5 to 75.0 wt % or from 2.0 to 50 wt % or from 2.5 to 35.0 wt %, based on the total weight of said solution.

It is an advantage of the present process that it is substantially non-polluting. More particularly, if the CO feed material contains any halide or hydrogen constituents, they will react to form additional hydrogen halide products. Any nitrogen constituents of a CO comprising feed material generally are released as elemental nitrogen, which may of course be emitted to the atmosphere. The gaseous carbon dioxide product of the reaction also may be safely vented to the atmosphere, or used in downstream reactions.

Hydrogen obtained with a process according to the invention may also be used in downstream applications. For instance, it may be used in ammonia synthesis, for hydrogenation purposes, for chemicals synthesis, or power generation by combustion in a gas turbine with or without additional hydrocarbon fuels, etc. Hydrogen produced can also be applied as a chemical feedstock to reduce dependence on petroleum and natural gas.

In some embodiments of the invention, it is another advantage that substantially little, or in some cases, no external heat is required to maintain the desired reaction temperatures in each step. More particularly, the reaction of the CO feed stream, water, and halogen is exothermic, and in many instances sufficient to supply all the heat required to maintain the desired temperatures in the first reaction zone, or in the first step, and further provide an aqueous hydrogen halide solution having a temperature within the range of that preferred for the electrolytic decomposition step. Thus, the only significant amount of energy required in accordance with such embodiments, is electrical energy for the electrolytic decomposition.

In addition, in those embodiments of the present process in which a complexing agent is applied in step b) of the process, the invention provides the further advantage that complexes of free halogen atoms (e.g. bromine), can be formed. This allows to reduce the potential of the electrolytic process and therefore reduces the required energy. In particular, in certain embodiments, the energy demand of process step b) may be lower than 1.09 V (versus SHE), and preferably lower than 1.07 V (versus SHE), or lower than 1.05 V (versus SHE).

The “standard hydrogen electrode (abbreviated SHE)” is a redox electrode which forms the basis of the thermodynamic scale of oxidation-reduction potentials. To form a basis for comparison with all other electroreactions, hydrogen's standard electrode potential (E°) is declared to be zero volts (0 V) at any temperature. Potentials of any other electrodes are compared with that of the standard hydrogen electrode at the same temperature.

### System

The present invention further provides a system for producing hydrogen and carbon dioxide from carbon monoxide and water, wherein the system comprises:
at least one first reaction zone configured to react a feed stream comprising carbon monoxide (CO) with water (H₂O) and at least one halogen reactant (X₂) such as bromine (Br₂) into a gaseous CO₂-containing effluent stream and an aqueous solution of hydrogen halide (HX), such as hydrogen bromide; and
at least one second reaction zone, separated from said first reaction zone, and configured to receive an aqueous solution of hydrogen halide, such as hydrogen bromide, and to decompose said hydrogen halide solution, such as hydrogen bromide solution, into a gaseous H₂-rich stream and a stream comprising halogen reactant, such as bromine.

In preferred embodiments, the second reaction zone comprises an electrolysis unit comprising at least one electrolysis cell and a power source for supplying current to said electrolysis cell.

A particularly suitable electrolysis cell is a polymer electrolyte membrane cell (PEM) containing at least a proton-conductive membrane. One of the largest advantages to PEM electrolysis is its ability to operate at high current densities. This can result in reduced operational costs. The polymer electrolyte allows a PEM electrolytic cell to operate with a very thin membrane (˜100-200 μm) while still allowing high pressures, resulting in low ohmic losses, primarily caused by the conduction of protons across the membrane (0.1 S/cm) and a compressed hydrogen output. The polymer electrolyte membrane, due to its solid structure, advantageously gives very high product gas purity.

A system according to the present invention further comprises
means for supplying a feed stream comprising carbon monoxide to said first reaction zone;
means for supplying water to said first reaction zone; and
means for supplying a solution of a halogen reactant, such as bromine, to said first reaction zone.

Such means for supplying reactants to the first reaction zone may include inlet lines (conduits), optionally provided with controlling means for controlling flow rate of the reactant streams to the reaction zone. In preferred embodiments of the invention separate means (separate inlet lines or conduits) may be provided for each of the reactants in the process, i.e. separately for the CO feedstock, the water (supplied as water or as vapour), and the halogen reactant (such as bromine).

In addition, a system according to the present invention further comprises means for separately recovering a gaseous CO₂-containing effluent stream and an aqueous solution of hydrogen halide, such as hydrogen bromide, from said first reaction zone. Such means include for instance:
at least one outlet line (conduit) for recovering a gaseous CO₂-containing effluent stream from said first reaction zone, and
at least one outlet line (conduit) for recovering an aqueous solution of hydrogen halide, such as aqueous hydrogen bromide, from said first reaction zone.

A system in accordance with the present invention further comprises means, in particular at east one inlet line, for supplying an aqueous solution of hydrogen halide, such as aqueous solution of hydrogen bromide, recovered from said first reaction zone to said second reaction zone.

Certain embodiments of the present system may further comprise a filter unit which is configured to remove solids, that may be suspended in the aqueous solution of hydrogen halide (such as hydrogen bromide) withdrawn from the first reaction zone, prior to supply thereof to the second reaction zone.

A system in accordance with the present invention further comprises for separately recovering a gaseous H₂-rich stream and a stream comprising halogen reactant, such as bromine, from said second reaction zone. Such means comprise for instance
at least one outlet line for recovering a gaseous H₂-rich stream from said second reaction zone, and
at least one outlet line for recovering a stream comprising halogen reactant, such as bromine, from said second reaction zone.

Optionally, the system of the invention may be provided with means (e.g. a transfer line or conduit) for returning the stream of halogen reactant, such as bromine, recovered from said second reaction zone, or a least a part thereof, to said first reaction zone.

Optionally, the system of the invention may also be provided with means (e.g. an inlet line or conduit) for supplying a complexing agent, such as those defined herein, to the second reaction zone. The following examples serve to merely illustrate the invention and should not be construed as limiting its scope in any way. While the invention has been shown in only some of its forms, it should be apparent to those skilled in the art that it is not so limited, but is susceptible to various changes and modifications without departing from the scope of the invention.

### EXAMPLES

### Example 1

The following example illustrates a process of the invention in which a feedstock containing CO is converted into separate streams of CO₂ and hydrogen.

An experimental setup comprising a vertical quartz reactor (20 mm ID), two syringe pumps, two evaporators, cold trap and GC analyser was used in this example.

In a first step, a bottle of CO (>99.5 mol. %, Praxair) equipped with a pressure reductor and Bronkhorst mass-flow controller was used for feedstock delivery. The temperature of the reactor was kept at 800° C. during all the experiment. The following flow rates of CO (187 mL/min) and N2 (435 mL/min) were used during the experiment. At the beginning of the experiment, the flow of feedstock was kept for 20 min to stabilize, then the feed of Br₂ (≥99.5 vol. %, Sigma-Aldrich) of 32 g/h and demineralized water of 4 g/h was started and kept for 1 h.

The effluent of the reactor was passed through a cold trap (15° C.) containing dilute HBr solution (10 wt %) to condense unreacted water, HBr and capture unreacted bromine, prior to entering the GC. The GC program was adjusted to have 4.5 min long injections suitable for detection of the nitrogen, CO, and CO₂. Results of the GC analysis are depicted in FIG. 1.

The conversion of CO into CO₂ was calculated on the basis of GC data, the following formula:

$$x ( CO ) = \frac{n ( {CO}_{feed} ) - n ( {CO}_{effluent} )}{n ( {CO}_{feed} )}$$

and corresponded to 28%.

The GC chromatograms contained a residual peak with retention time attributed to hydrogen. However, low intensity of the peak made integration impossible and it was assumed to be at noise level.

The amount of unreacted bromine was determined by the titration of an aliquot collected from the cold trap. An excess of aqueous KI solution was added to the aliquot and then released iodine was titrated with Na₂S₂O₃ solution with colloidal starch as an indicator (n(Br₂)).

The conversion of bromine was calculated as follows:

$$x ( Br 2 ) = \frac{n ( Br {2}_{feed} ) - n ( Br {2}_{trap} )}{n ( Br {2}_{feed} )}$$

Total amount of unreacted Br₂ (0.073 mol) corresponded to 64% conversion in this example.

An electrolysis cell (10 cm²) comprising graphitic bipolar electrode, Nafion membrane and two Ti electrodes was assembled. The Cathode side was equipped with a gas distribution electrode with Pt catalyst distributed on porous carbon. In an electrolysis step, a HBr solution (48 wt. %) was fed by means of a custom-made teflonized syringe pump with a constant flow rate of 8 mL/min. The current density during cell operation comprised 0.35 A/cm². The cell demonstrated stable operation for >9 h, as illustrated in FIG. 2.

Liquid after the experiment was collected and a sample of 10 mL was analysed using iodometric titration approach. The conversion of Br₂ was analysed by titration of two aliquots collected from the flask containing the effluent from anode side of the cell. First, hydrogen was bubbled through the first aliquot to convert Br₂ into HBr. The disappearance of red colour indicates that the reaction was finished and total amount of HBr analysed by acid-base titration with sodium hydroxide solution and a pH meter as an indicator (n(HBrₜₒₜ)). Then, the titration of bromine in the second aliquot was performed by adding excess of aqueous KI solution. Released iodine was titrated with Na₂S₂O₃ solution with colloidal starch as an indicator (n(Br₂)). The conversion of bromine was calculated as follows:

$$x ( Br 2 ) = \frac{n ( {HBr}_{tot} ) - 2 * n ( Br 2 )}{n ( {HBr}_{tot} )}$$

Determined bromine concentration corresponds to 38.76% conversion of the HBr.

### Example 2

The following example demonstrates a preferred embodiment of the process of the present invention, utilizing separate reaction zones for the two reaction steps.

More particularly, with reference to FIG. 3, the present invention will be described with respect to a preferred source of halogen, i.e. bromine.

A feed stream comprising CO containing about 100 mol. % CO is introduced into a first reaction zone 1, e.g. at a rate of 2800 kg/hr via inlet 3. A liquid phase consisting of dilute hydrogen bromide in water and containing dissolved bromine is brought into the first reaction zone via an inlet 4. Water is also (preferably directly such as via inlet 5) introduced into the first reaction zone 1, e.g., in an amount of about 1460 kg/hr. The first reaction zone 1 is maintained at a temperature of about 300-600° C. and a pressure from 10 to 80 bar.

A gaseous effluent stream comprising CO₂ is withdrawn via outlet line/conduit 6.

An aqueous solution of the hydrogen bromide reaction product formed in the first reaction zone 1 is withdrawn via a conduit 7, optionally passed through a filter 8 to remove suspended solids and introduced via a conduit 9 into a second reaction zone 2.

In the second reaction zone the aqueous solution is electrolytically decomposed at a temperature of about 70° C., and under a pressure from about 2 to 10 bar. The electrical power requirements to provide a desired decomposition potential of from about 0.5 to about 2.5 V and a current density from about 100 to 800 mA/cm².

Gaseous hydrogen is produced in the second reaction zone 2 at a rate of about 185 kg/hr and withdrawn via a conduit 10 for recovery. A solution depleted in hydrogen bromide and containing dissolved bromine is withdrawn from the second reaction zone 2 via conduit 11 and can be returned to the first reaction zone 1 for reaction with the feed stream containing CO.

### Example 3

This example illustrates step b) of the process of the invention, which is carried out in the presence and in the absence of an ionic liquid as complexing agent, and in particular 1-n-Butyl-3-methylimidazolium bromide.

### Experiment 1

In one experiment, an electrolysis cell (10 cm²) comprising graphitic bipolar electrode, Nafion membrane and two Ti electrodes was assembled. The Cathode side was equipped with a gas distribution electrode with Pt catalyst distributed on porous carbon.

In this electrolysis step, a HBr solution (42 wt %) containing 4 wt % of 1-n-Butyl-3-methylimidazolium bromide (obtained from Alfa Aesar) as complexing agent and balance of deionized water was applied. The HBr was supplied by a custom-made teflonized syringe pump with a constant flow rate of 8 mL/min. The current density during cell operation comprised 0.35 A/cm². The test was carried out for 50 min.

Liquid after the experiment was collected and a sample of 10 mL was analysed using iodometric titration approach. The conversion of Br₂ was analysed by titration of two aliquots collected from the flask containing the effluent from anode side of the cell. First, hydrogen was bubbled through the first aliquot to convert Br₂ into HBr. The disappearance of red colour indicates that the reaction was finished and total amount of HBr analysed by acid-base titration with sodium hydroxide solution and a pH meter as an indicator (n(HBrₜₒₜ)). Then, the titration of bromine in the second aliquot was performed by adding excess of aqueous KI solution. Released iodine was titrated with Na₂S₂O₃ solution with colloidal starch as an indicator (n(Br₂)).

The conversion of bromine was calculated as follows:

$$x ( Br 2 ) = \frac{n ( {HBr}_{tot} ) - 2 * n ( Br 2 )}{n ( {HBr}_{tot} )}$$

The determined bromine concentration corresponds to 36.6% conversion of the HBr.

The total energy used corresponds to 2.21 W*h, wherein Wh=E*I*t, with E[V] being the average potential of the reaction, I[A] being the total current passing through cell and T being the time of cell operation.

### Experiment 2

The same cell from Experiment 1 was used with a HBr solution containing 42 wt % of HBr and balance of deionized water as a feedstock. No complexing agent was added. The feed rate was maintained at constant flow rate of 8 mL/min. The current density during cell operation comprised 0.35 A/cm². The total test run comprised 50 min.

Liquid after the test was collected and a sample of 10 mL was analysed using iodometric titration approach in the same way as explained for example 1. The determined bromine concentration corresponds to 35.7% conversion of the HBr.

The total energy used corresponds to 2.71 W*h.

FIG. 4 illustrates the energy requirement (in cell voltage) for carrying out the processes according to experiments 1 and 2, and shows a lower energy demand in case of carrying out this step of the process according to the invention in the presence of a complexing agent.

### Example 4

This example illustrates 3 experiments wherein step b) of the process of the invention is carried out in the presence of a complexing agent.

### Experiment 1

An electrolysis cell (10 cm²) comprising graphitic bipolar electrode, Nafion membrane and two Ti electrodes was assembled. The Cathode side was equipped with a gas distribution electrode with Pt catalyst distributed on porous carbon.

In this electrolysis step, a HBr solution (42 wt %) containing 10 wt % of acetonitrile (obtained from Alfa Aesar) as complexing agent and balance of deionized water was applied. The HBr was supplied by a custom-made teflonized syringe pump with a constant flow rate of 8 mL/min. The current density during cell operation comprised 0.35 A/cm². The test was carried out for 50 min.

Liquid after the experiment was collected and a sample of 10 mL was analysed using iodometric titration approach. The conversion of Br₂ was analysed by titration of two aliquots collected from the flask containing the effluent from anode side of the cell. First, hydrogen was bubbled through the first aliquot to convert Br₂ into HBr. The disappearance of red colour indicates that the reaction was finished and total amount of HBr analysed by acid-base titration with sodium hydroxide solution and a pH meter as an indicator (n(HBrₜₒₜ)). Then, the titration of bromine in the second aliquot was performed by adding excess of aqueous KI solution. Released iodine was titrated with Na₂S₂O₃ solution with colloidal starch as an indicator (n(Br₂)).

The conversion of bromine was calculated as follows:

$$x ( Br 2 ) = \frac{n ( {HBr}_{tot} ) - 2 * n ( Br 2 )}{n ( {HBr}_{tot} )}$$

The determined bromine concentration corresponds to 37.3% conversion of the HBr.

The total energy used corresponds to 2.00 W*h, wherein Wh=E*I*t, with E [V] being the average potential of the reaction, I [A] being the total current passing through cell and T being the time of cell operation.

### Experiment 2

The same cell from experiment 1 was used with a HBr solution containing 42 wt % of HBr, 7% of 1,4-dioxane (Sigma-Aldrich) and balance of deionized water as a feedstock. The feed rate was maintained at constant flow rate of 8 mL/min. The current density during cell operation comprised 0.35 A/cm². The total test run comprised 50 min.

Liquid after the test was collected and a sample of 10 mL was analysed using iodometric titration approach in the same way as explained for example 1. The determined bromine concentration corresponds to 37.9% conversion of the HBr.

The total energy used corresponds to 2.18 W*h.

### Experiment 3

The same cell from experiment 1 was used with a HBr solution containing 42 wt % of HBr, 7% of N,N-dimethylpropylamine (Sigma-Aldrich) and balance of deionized water as a feedstock. The feed rate was maintained at constant flow rate of 8 mL/min. The current density during cell operation comprised 0.35 A/cm². The total test run comprised 50 min.

Liquid after the test was collected and a sample of 10 mL was analysed using iodometric titration approach in the same way as explained for example 1. The determined bromine concentration corresponds to 34.2% conversion of the HBr.

The total energy used corresponds to 2.13 W*h.

FIG. 5 illustrates the energy requirement (in cell voltage) for carrying out the processes according to experiments 1, 2 and 3. For comparison, the energy requirement as reported in example 3 (experiment 2) is also illustrated. Example 4 illustrates that an electrolysis step in the process of the invention when carried out in the presence of a complexing agent has beneficial effect on the energy demand and requires a lower energy demand.

1. Process for producing hydrogen and carbon dioxide from carbon monoxide and water, comprising the steps of:
a) reacting in a first reaction zone a feed stream comprising carbon monoxide (CO) with water (H₂O) and a halogen reactant, wherein said halogen reactant is bromine (Br₂) under reaction conditions effective to produce a gaseous CO₂-containing effluent stream and an aqueous solution of hydrogen bromide (HBr); and,
b) supplying said aqueous solution of hydrogen bromide (HBr) to a second reaction zone and decomposing by means of electrolysis said hydrogen bromide (HBr) under conditions effective to produce a gaseous H₂-rich stream and a stream comprising bromine (Br₂).

2. Process according to claim 1, further comprising the step of returning the halogen reactant obtained in step b), or a part thereof, to step a) of the process.

3. Process according to claim 1, wherein the feed stream reacted in step a) comprises at least 5.0 mol % carbon monoxide, such as at least 10.0 mol %, or at least 20.0 mol %, or at least 50.0 mol %, or at least 70.0 mol %, or at least 90.0 mol %, or at least 99.0 mol % of carbon monoxide.

4. Process according to claim 1, wherein the feed stream comprising carbon monoxide (CO) reacted in step a) is an effluent stream from a CO-generating process selected from a combustion process of a carbon-containing feedstock, a conversion process of a hydrocarbon-containing feedstock, such as natural gas, mineral oils, or coal; or a coal gasification process.

5. Process according to claim 1, wherein the feed stream comprising carbon monoxide (CO) reacted in step a) comprises a solvent suitable for the dissolution of carbon monoxide in said feed stream, and preferably said solvent is an organic solvent, preferably selected from the group consisting of aromatics, aromatic alcohols, alkyl halides, (aliphatic) amines, aromatic amines, carboxylic acids, ethers, esters, alcohols and organic nitrates.

6. Process according to claim 1, wherein step a) of said process is carried out in the absence of a catalyst.

7. Process according to claim 1, wherein said feed stream is reacted in step a) at a reaction temperature of at least 40° C.

8. Process according to claim 1, wherein said step a) is carried out at a reaction pressure comprised between 1 and 150 bar.

9. Process according to claim 1, wherein step b) of said process comprises supplying an aqueous solution of hydrogen bromide to an electrolysis cell containing positive and negative electrodes, and decomposing said hydrogen bromide electrolytically by maintaining an electrical potential from 0.5 to 2.5 V between said electrodes.

10. Process according to claim 1, wherein step b) of said process comprises supplying an aqueous solution of hydrogen bromide to an electrolysis cell containing positive and negative electrodes, and decomposing said hydrogen bromide electrolytically by maintaining a current density from 100 to 800 mA/cm² between said electrodes.

11. Process according to claim 1, wherein step b) is carried out in the presence of a complexing agent.

12. Process according to claim 1, wherein said hydrogen bromide is decomposed at a temperature of from 20 to 95° C.

13. Process according to claim 1, wherein said hydrogen bromide is decomposed at a pressure of from 1 to 50 bar.

14. Process according to claim 1, wherein the gaseous CO₂-containing effluent stream obtained in step a) comprises at least 5.0 mol %, such as at least 20.0 mol % of CO₂, or at least 50.0 mol % of CO₂, or at least 90.0 mol % CO₂, or at least 95.0 mol % CO₂, or at least 99.0 mol % CO₂, or at least 99.5 mol % CO₂.

15. Process according to claim 1, wherein the molar ratio of CO/CO₂ in said gaseous CO₂-containing effluent stream is lower than 0.2, such as lower than 0.1.

16. Process according to claim 1, wherein said hydrogen-rich stream generated in step b) comprises at least 90.0 mol %, such as at least 95.0 mol %, or at least 99.0 mol %, or at least 99.5 mol %, or at least 99.9 mol % hydrogen.

17. System for producing hydrogen and carbon dioxide from carbon monoxide and water, comprising
at least one first reaction zone configured to react a feed stream comprising carbon monoxide (CO) with water (H₂O) and a halogen reactant, wherein said halogen reactant is bromine (Br₂) into a gaseous CO₂-containing effluent stream and an aqueous solution of hydrogen bromide (HBr);
at least one second reaction zone, separated from said first reaction zone, and configured to receive an aqueous solution of hydrogen bromide and to decompose said hydrogen bromide solution into a gaseous H₂-rich stream and a stream comprising bromine;
means for supplying a feed stream comprising carbon monoxide (CO) to said first reaction zone;
means for supplying water to said first reaction zone;
means for supplying a solution of a bromine to said first reaction zone;
means for separately recovering a gaseous CO₂-containing effluent stream and an aqueous solution of hydrogen bromide (HBr) from said first reaction zone;
means for supplying an aqueous solution of hydrogen bromide (HBr) recovered from said first reaction zone to said second reaction zone,
means for separately recovering a gaseous H₂-rich stream and a stream comprising bromine from said second reaction zone; and
optionally, means for returning the stream of bromine, or a part thereof, recovered from said second reaction zone to said first reaction zone,
wherein said second reaction zone comprises an electrolysis unit comprising at least one electrolysis cell and a power source for supplying current to said electrolysis cell, and
optionally, means for supplying a complexing agent to said second reaction zone.
